(19) United States
(12) Patent Application Publication
(10) Pub. No.: US 2025/0181292 A1
(43) Pub. Date: Jun. 5, 2025

(54) PRINTING SYSTEM, PRINTING CONTROL APPARATUS, PRINTING CONTROL METHOD, AND RECORDING MEDIUM

(71) Applicants: Ayano Nakamura, Tokyo (JP); Reika Sugiyama, Tokyo (JP)

(72) Inventors: Ayano Nakamura, Tokyo (JP); Reika Sugiyama, Tokyo (JP)

(73) Assignee: Ricoh Company, Ltd., Tokyo (JP)

(21) Appl. No.: 18/944,488

(22) Filed: Nov. 12, 2024

(30) Foreign Application Priority Data
Nov. 30, 2023 (JP) 2023-202507

(51) Int. Cl. G06F 3/12; B41F 33/00; B41J 29/00; G03G 15/00

(52) U.S. Cl. CPC G06F 3/1275; B41F 33/0009; B41J 29/00; G03G 15/553; G06F 3/1205; G06F 3/1253

(57) ABSTRACT

A printing control apparatus includes circuitry. The circuitry receives an input of a print job for an image forming apparatus, refers to, for each of a plurality of processes identified based on the print job, unit information stored in a memory and indicating a unit of a quantity for a corresponding one of the plurality of processes, and associates the quantity for each of the plurality of processes identified based on the print job with the unit of the quantity for the corresponding one of the plurality of processes.

### CROSS-REFERENCE TO RELATED APPLICATIONS

This patent application is based on and claims priority pursuant to 35 U.S.C. § 119(a) to Japanese Patent Application No. 2023-202507, filed on Nov. 30, 2023, in the Japan Patent Office, the entire disclosure of which is hereby incorporated by reference herein.

### BACKGROUND

### Technical Field

The present disclosure relates to a printing system, a printing control apparatus, a printing control method, and a recording medium.

### Related Art

A typical commercial printing system uses, for example, a management information system (MIS) to manage the progress of a print job and a processing result.

In a commercial printing system, processing apparatuses and applications execute a plurality of processes included in a digital workflow. The “quantities” in commercial printing are expressed in various units such as “the number of copies to be printed,” “the number of copies to be delivered,” “the number of sheets to be printed,” and “the number of pages,” depending on the content of the processes.

### SUMMARY

According to an embodiment of the present disclosure, a printing control apparatus includes circuitry. The circuitry receives an input of a print job for an image forming apparatus, refers to, for each of a plurality of processes identified based on the print job, unit information stored in a memory and indicating a unit of a quantity for a corresponding one of the plurality of processes, and associates the quantity for each of the plurality of processes identified based on the print job with the unit of the quantity for the corresponding one of the plurality of processes.

According to an embodiment of the present disclosure, a printing system includes the above-described printing control apparatus and the above-described image forming apparatus to print an image based on the print job.

According to an embodiment of the present disclosure, a printing control method includes receiving an input of a print job for an image forming apparatus, referring to, for each of a plurality of processes identified based on the print job, unit information stored in a memory and indicating a unit of a quantity for a corresponding one of the plurality of processes, and associating the quantity for each of the plurality of processes identified based on the print job with the unit of the quantity for the corresponding one of the plurality of processes.

According to an embodiment of the present disclosure, a non-transitory recording medium stores a plurality of instructions which, when executed by one or more processors, causes the one or more processors to perform the above-described printing control method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of a printing system;

FIG. 2A is a diagram illustrating an example of a hardware configuration of an image forming apparatus;

FIG. 2B is a diagram illustrating another example of the hardware configuration of the image forming apparatus;

FIG. 3 is a diagram illustrating an example of a hardware configuration of a printing control apparatus;

FIG. 4 is a diagram for describing functional configurations of the printing control apparatus and a client personal computer (PC);

FIG. 5 is a table illustrating an example of a print job storage section;

FIG. 6 is a table illustrating an example of an association storage section;

FIG. 7 is a table illustrating an example of a process pattern storage section;

FIG. 8 is a table illustrating an example of a job actual result information storage section;

FIG. 9 is a table illustrating an example of an input quantity calculation formula storage section;

FIG. 10 is a table illustrating an example of an actual quantity calculation formula storage section;

FIG. 11 is a table illustrating an example of a unit information storage section;

FIG. 12 is a diagram illustrating an example of a process pattern;

FIG. 13A is a first sequence diagram illustrating an operation of the printing system;

FIG. 13B is a second sequence diagram illustrating the operation of the printing system;

FIG. 14A is a third sequence diagram illustrating the operation of the printing system;

FIG. 14B is a fourth sequence diagram illustrating the operation of the printing system;

FIG. 15A is a first diagram for describing an advantageous effect of an embodiment of the present disclosure; and

FIG. 15B is a second diagram for describing the advantageous effect of the embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

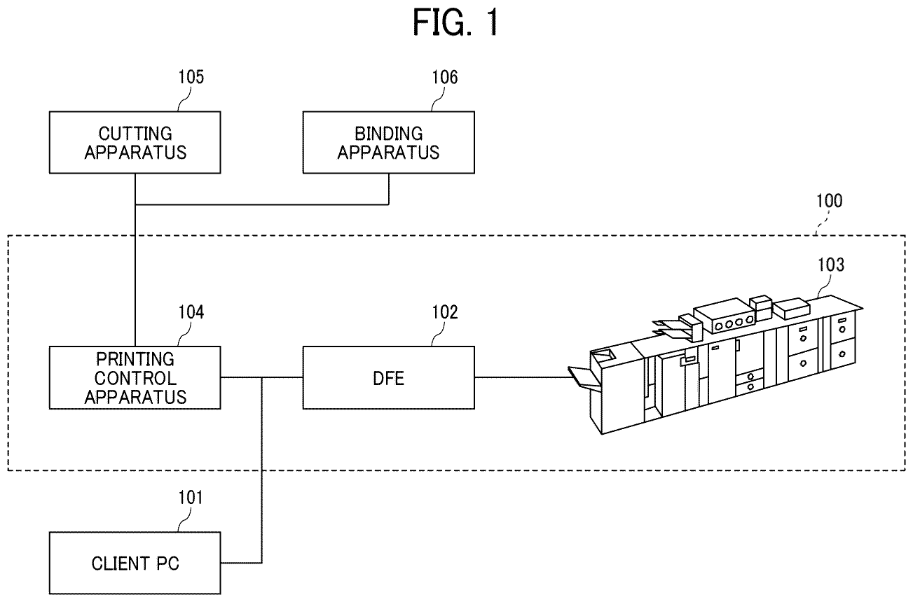

An embodiment of the present disclosure is described below with reference to the drawings. FIG. 1 is a diagram illustrating an example of a system configuration of a printing system.

A printing system 100 according to the present embodiment includes a digital front end (DFE) 102, an image forming apparatus 103, and a printing control apparatus 104. The printing control apparatus 104 according to the present embodiment is communicably connected to a client personal computer (client PC) 101, a cutting apparatus 105, and a binding apparatus 106.

The printing system 100 according to the present embodiment may be used for commercial printing, for example. Commercial printing refers to a business field in which a printing company or a printing office receives an order and payment from an orderer and prints and provides a printed matter as a product. Examples of the printed matter as a product include an advertisement, a direct mail, a poster, a booklet, and a book.

Each of the DFE 102, the image forming apparatus 103, the printing control apparatus 104, the cutting apparatus 105, and the binding apparatus 106 according to the present embodiment executes part of a plurality of processes included in a digital workflow in the commercial printing.

The digital workflow in the commercial printing refers to a processing order of processes from when a print job is input to when a printed matter to be delivered as a product is created. In other words, the digital workflow according to the present embodiment refers to information indicating a pattern of the processes from when a print job is input to when a printed matter to be delivered as a product is created, and indicates a plurality of processes associated with a print job.

Hereinafter, the digital workflow may be referred to as process pattern information. In the present embodiment, a process refers to processing that is automatically executed by a processing apparatus or an application.

In the present embodiment, the digital workflow in the commercial printing includes an imposition process, a printing process, a cutting process, and a binding process. However, the processes included in the digital workflow in the commercial printing are not limited thereto. The processes included in the digital workflow in the commercial printing may be part of these processes or may be processes other than these processes.

In the present embodiment, the DFE 102 and the image forming apparatus 103 execute the printing process. The printing control apparatus 104 executes the imposition process. The cutting apparatus 105 executes the cutting process. The binding apparatus 106 executes the binding process.

The imposition process executed by the printing control apparatus 104 may be executed by an imposition application installed in the printing control apparatus 104.

The printing control apparatus 104 may include a process management application installed therein to manage each process included in the digital workflow.

The printing control apparatus 104 according to the present embodiment also includes a quantity management application installed therein to manage the quantity for each process included in the digital workflow in association with the unit of the quantity.

The quantity management application according to the present embodiment manages, for each process included in the digital workflow, the quantity planned for the execution of a process and the unit of the quantity planned for the execution of the process in association with the quantity as a result of the actual execution of the process and the unit of the quantity as a result of the actual execution of the process.

In the present embodiment, the quantity and the unit of the quantity are managed in association with each other for each process as described above so that the progress of a print job and a processing result are appropriately managed.

The printing control apparatus 104 according to the present embodiment acquires, for each process, the planned quantity planned for the execution of the process and the quantity as a result of the actual execution of the process. Therefore, in the present embodiment, the quantity planned for the execution of the process is compared with the quantity as a result of the actual execution of the process so that a change in the processing content of each process is detectable. Therefore, when the processing content of a process that has not been executed yet is changed while the digital workflow is being executed, the printing control apparatus 104 according to the present embodiment notifies a user of the client PC 101 of the change.

The quantity planned for the execution of each process is referred to as “planned input quantity.” The planned input quantity in each process is a value that is determined by a corresponding quantity included in a print job and that is input to a processing apparatus or an application that executes the process.

The quantity indicating a planned execution result of each process is referred to as “planned actual quantity.” The planned actual quantity in each process is a value that is determined by a corresponding quantity included in a print job and that is output from a processing apparatus or an application that executes the process.

In each process, the quantity actually input to a processing apparatus or an application that executes the corresponding process is referred to as “input quantity.” The input quantity for each process may be a value that is acquired as a processing result of a preceding process or may be a value that is input by the user of the printing control apparatus 104 before the process is executed.

In each process, the quantity output from a processing apparatus or an application as a result of executing the corresponding process is referred to as “actual quantity.”

In the printing system 100, the client PC 101 creates a print job for a document or a file the user wants to print and transmits the print job to the DFE 102 or the printing control apparatus 104. The client PC 101 also includes a display device, which is a liquid-crystal display (LCD), and input devices such as a mouse and a keyboard.

A print job refers to a set of electronic files relating to a print request transmitted from the client PC 101 to the DFE 102 or the printing control apparatus 104. For example, a print job includes content data (electronic data) to be printed and print setting information (hereinafter referred to as a “printing condition”) indicating a printing condition for content data.

A print job may include print data acquired by converting the content data into a page description language (PDL) format that is printable by the image forming apparatus 103 in accordance with the printing condition.

The content data refers to input content data that is the original of a printed matter to be a product and includes document data and image data. The printing condition includes various pieces of information relating to printing of the content data. Examples of the information included in the printing condition include the type of product (printed matter), the number of copies to be printed, the sheet size, color printing, double-sided printing, and stapling.

The DFE 102 receives a print job from the client PC 101 or the printing control apparatus 104, and creates, based on the received print job, drawing data using a raster image processor (RIP) engine and transmits the drawing data to the image forming apparatus 103.

The image forming apparatus 103 performs an image forming operation based on the drawing data received from the DFE 102. In other words, the image forming apparatus 103 executes a print job. The image forming apparatus 103 is mainly an image forming apparatus for commercial printing. The image forming apparatus 103 may be an electrophotographic apparatus, an inkjet apparatus (liquid discharge apparatus), an offset apparatus, or a multifunction peripheral (MFP).

Commercial printing refers to a business field in which a printing company or a printing office receives an order and payment from an orderer and prints and provides a printed matter as a product. Examples of the printed matter as the product include an advertisement, a direct mail, a poster, a booklet, and a book. In other words, content data (input content data) included in a print job according to the present embodiment may be electronic data of, for example, an advertisement, a direct mail, a poster, a booklet, or a book.

The cutting apparatus 105 is one of finishers and executes cutting based on position information generated in the imposition process or position information directly input by an operator.

The binding apparatus 106 is one of the finishers and binds documents into a book or a booklet by a method such as saddle stitching or perfect binding (case binding). Saddle stitching is a binding method in which sheets are folded in half and stapled. Perfect binding is a binding method in which interior pages and a cover covering the interior pages are bound along the spine using adhesive.

The printing control apparatus 104 manages a print job received from the client PC 101. The printing control apparatus 104 transmits the print job to the DFE 102 in response to a request from the DFE 102.

In the example of FIG. 1, the printing control apparatus 104 is a single information processing apparatus. However, the present disclosure is not limited thereto. In another embodiment, the printing control apparatus 104 may be implemented by two or more information processing apparatuses. In the present embodiment, moreover, the image forming apparatus 103 may be an MFP.

In the example of FIG. 1, the client PC 101, the cutting apparatus 105, and the binding apparatus 106 are not included in the printing system 100. However, the present disclosure is not limited thereto. The client PC 101, the cutting apparatus 105, and the binding apparatus 106 may be included in the printing system 100.

When the client PC 101 is included in the printing system 100, the client PC 101 may also serve as the printing control apparatus 104.

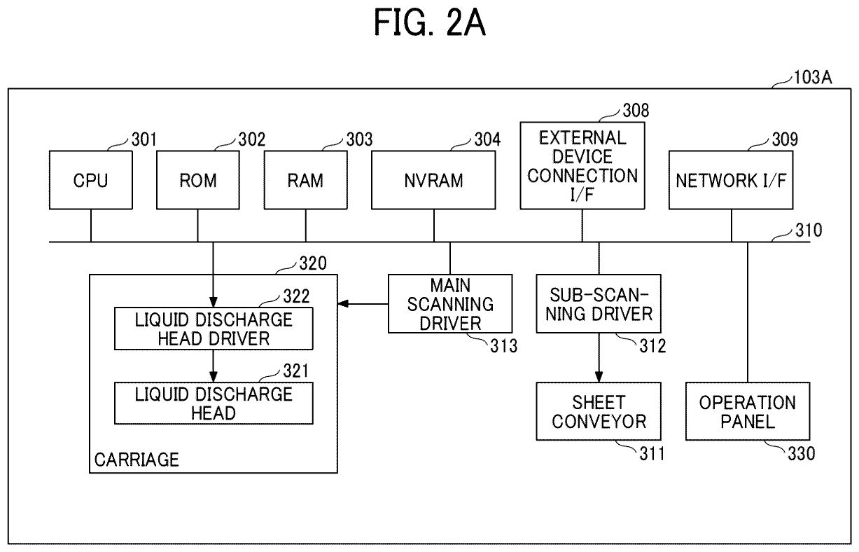

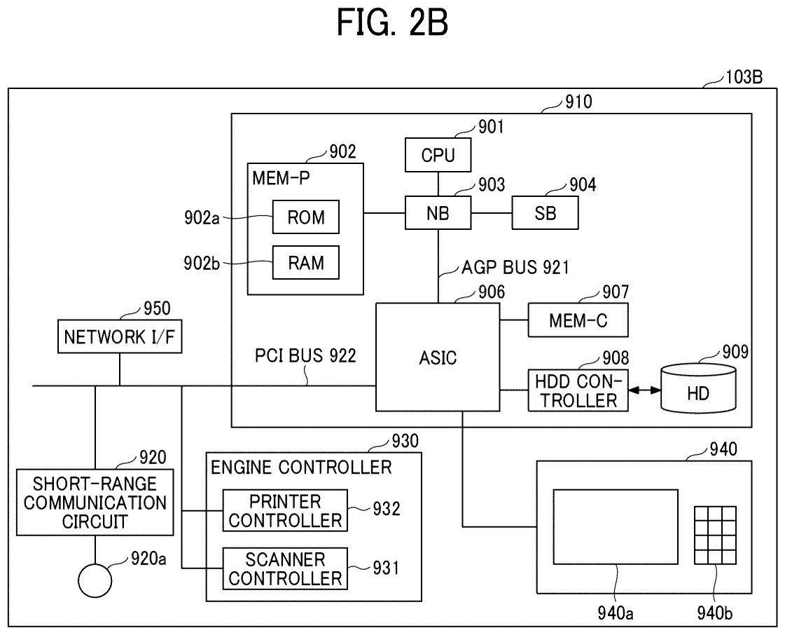

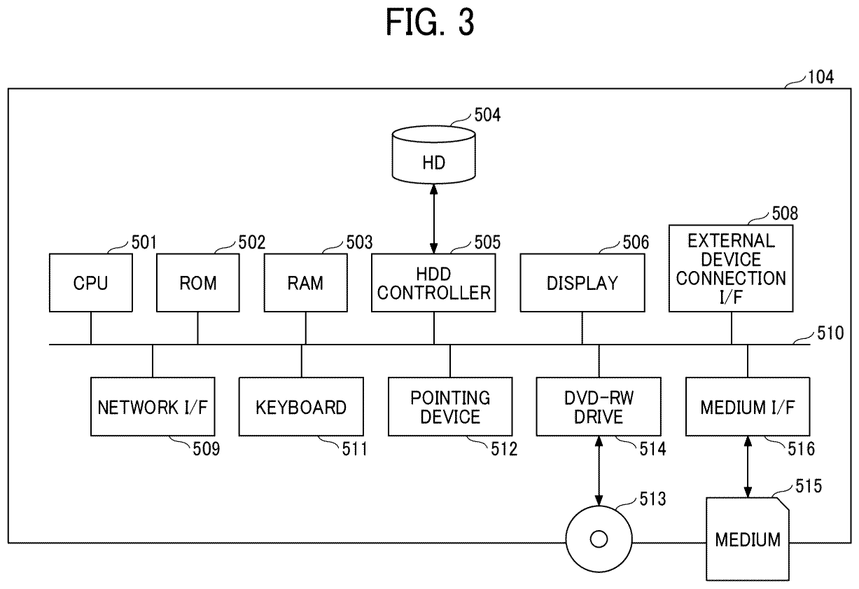

Hardware configurations of the image forming apparatus 103 and the printing control apparatus 104 included in the printing system 100 according to the present embodiment are described below with reference to FIGS. 2A, 2B, and 3.

FIG. 2A is a diagram illustrating an example of the hardware configuration of the image forming apparatus 103. Specifically, FIG. 2A illustrates the hardware configuration of the image forming apparatus 103 when the image forming apparatus 103 is an inkjet apparatus (liquid discharge apparatus) 103A.

As illustrated in FIG. 2A, the liquid discharge apparatus 103A includes a central processing unit (CPU) 301, a read-only memory (ROM) 302, a random-access memory (RAM) 303, a non-volatile RAM (NVRAM) 304, an external device connection interface (I/F) 308, a network I/F 309, and a bus line 310. The liquid discharge apparatus 103A also includes a sheet conveyor 311, a sub-scanning driver 312, a main scanning driver 313, a carriage 320, and an operation panel 330. The carriage 320 includes a liquid discharge head 321 and a liquid discharge head driver 322.

The CPU 301 controls the entire operation of the liquid discharge apparatus 103A. The ROM 302 stores, for example, a program such as an initial program loader (IPL) used to drive the CPU 301. The RAM 303 is used as a work area of the CPU 301. The NVRAM 304 stores various data such as a program and retains various data even while power to the liquid discharge apparatus 103A is cut off. The external device connection I/F 308 is connected to a PC through, for example, a universal serial bus (USB) cable and communicates with the PC to transmit a control signal and receive data to be printed. The network I/F 309 is an interface for data communication using a communication network such as the Internet. The bus line 310 includes an address bus and a data bus that electrically connect components such as the CPU 301 to each other.

The sheet conveyor 311 includes, for example, a roller and a motor that drives the roller, and conveys a print sheet in a sub-scanning direction along a conveyance path in the liquid discharge apparatus 103A. The sub-scanning driver 312 controls the movement of the sheet conveyor 311 in the sub-scanning direction. The main scanning driver 313 controls the movement of the carriage 320 in a main scanning direction.

The liquid discharge head 321 of the carriage 320 includes a plurality of nozzles that discharges liquid such as ink and is mounted on the carriage 320 such that a discharge face (nozzle face) of the liquid discharge head 321 faces a print sheet. While the liquid discharge head 321 moves in the main scanning direction, the liquid discharge head 321 discharges liquid to the print sheet intermittently conveyed in the sub-scanning direction so that an image is formed with the liquid discharged at a predetermined position of the print sheet. The liquid discharge head driver 322 is a driver that controls the driving of the liquid discharge head 321.

The operation panel 330 includes, for example, a touch panel and an alarm lamp. The touch panel displays a current setting value and a selection screen and receives an input from an operator.

The liquid discharge head driver 322 may be connected to the bus line 310 without being mounted on the carriage 320. The main scanning driver 313, the sub-scanning driver 312, and the liquid discharge head driver 322 may be functions that are implemented by instructions of the CPU 301 according to a program.

FIG. 2B is a diagram illustrating another example of the hardware configuration of the image forming apparatus 103. Specifically, FIG. 2B illustrates the hardware configuration of the image forming apparatus 103 when the image forming apparatus 103 is an electrophotographic apparatus 103B.

As illustrated in FIG. 2B, the electrophotographic apparatus 103B includes a controller 910, a short-range communication circuit 920, an engine controller 930, an operation panel 940, and a network I/F 950.

The controller 910 includes a CPU 901, which is a main component of the computer, a system memory (MEM-P) 902, a north bridge (NB) 903, a south bridge (SB) 904, an application-specific integrated circuit (ASIC) 906, a local memory (MEM-C) 907, which is a storage area, a hard disk drive (HDD) controller 908, and a hard disk (HD) 909, which is a storage area. The NB 903 and the ASIC 906 are connected to each other via an accelerated graphics port (AGP) bus 921.

The CPU 901 is a controller that performs the overall control of the electrophotographic apparatus 103B. The NB 903 is a bridge that connects the CPU 901, the MEM-P 902, the SB 904, and the AGP bus 921 to each other. The NB 903 includes a memory controller, which controls reading and writing of various data from and to the MEM-P 902, a peripheral component interconnect (PCI) master, and an AGP target.

The MEM-P 902 includes a ROM 902a and a RAM 902b. The ROM 902a is a memory that stores a program and data for implementing various functions of the controller 910. The RAM 902b is used as a memory into which a program and data are deployed and also used as a drawing memory that stores drawing data for printing. The program stored in the RAM 902b may be stored in any computer-readable recording medium, such as a compact-disc read-only memory (CD-ROM), a compact-disc recordable (CD-R), or a digital versatile disc (DVD), in a file format installable or executable by a computer, for distribution.

The SB 904 is a bridge that connects the NB 903 to a PCI device and a peripheral device. The ASIC 906 is an integrated circuit (IC) for image processing applications which includes hardware components for image processing. The ASIC 906 functions as a bridge that connects the AGP bus 921, a PCI bus 922, the HDD controller 908, and the MEM-C 907 to each other. The ASIC 906 includes a PCI target, an AGP master, an arbiter (ARB), a memory controller, a plurality of direct memory access controllers (DMACs), and a PCI device. The arbiter is a main component of the ASIC 906. The memory controller controls the MEM-C 907. The plurality of DMACs performs processing such as the rotation of image data with a hardware logic. The PCI device transfers data to and from a scanner controller 931 and a printer controller 932 via the PCI bus 922. The ASIC 906 may be connected to an interface conforming to a standard such as universal serial bus (USB) or institute of electrical and electronics engineers (IEEE) 1394.

The MEM-C 907 is a local memory used as a printing image buffer and a code buffer. The HD 909 is a storage that stores image data, font data for use in printing, and form data. The HDD controller 908 controls writing and reading of data to and from the HD 909 under the control of the CPU 901. The AGP bus 921 is a bus interface for a graphics accelerator card proposed to accelerate graphics processing. The AGP bus 921 enables the graphics accelerator card to directly access the MEM-P 902 with a high throughput, thereby implementing a high-speed graphics accelerator card.

The short-range communication circuit 920 includes an antenna 920a. The short-range communication circuit 920 is a communication circuit conforming to a standard such as near-field communication (NFC) or Bluetooth™.

The engine controller 930 includes the printer controller 932. The engine controller 930 may also include the scanner controller 931. The operation panel 940 includes a panel display 940a and operation buttons 940b. The panel display 940a is implemented by, for example, a touch panel to display current setting values and a selection screen and receive an input from a user such as an operator. The operation buttons 940b include keys such as numeric keys for receiving the setting values of various conditions relating to image formation such as a density setting condition and a start key for receiving a copy start instruction. The controller 910 controls the entire electrophotographic apparatus 103B to control, for example, drawing, communication, and an input from the operation panel 940. At least one of the scanner controller 931 and the printer controller 932 executes various image processing such as error diffusion or gamma conversion.

The operation panel 940 may include an application switching key to allow the user to switch functions of the electrophotographic apparatus 103B among a printer function, settings, color adjustment, printing, and maintenance schedule management. The operation panel 940 may allow the user to sequentially switch a document box function, a copy function, and a facsimile function to select one of these functions. The network I/F 950 is an interface for data communication via a communication network. The short-range communication circuit 920 and the network I/F 950 are electrically connected to the ASIC 906 via the PCI bus 922.

FIG. 3 is a diagram illustrating an example of the hardware configuration of the printing control apparatus 104 according to the present embodiment. The printing control apparatus 104 according to the present embodiment is, for example, implemented by a computer and includes a CPU 501, a ROM 502, a RAM 503, an HD 504, an HDD controller 505, a display 506, an external device connection I/F 508, a network I/F 509, a data bus 510, a keyboard 511, a pointing device 512, a DVD rewritable (DVD-RW) drive 514, and a medium I/F 516.

The CPU 501 controls the entire operation of the printing control apparatus 104. The ROM 502 stores, for example, a program such as an IPL for executing the CPU 501. The RAM 503 is used as a work area for the CPU 501. The HD 504 stores various data such as a program. The HDD controller 505 controls reading and writing of various data from and to the HD 504 under the control of the CPU 501. The display 506 displays various pieces of information such as a cursor, menus, windows, characters, and images. The external device connection I/F 508 is an interface for connecting the printing control apparatus 104 to various external devices and apparatuses such as a USB memory and a printer. The network I/F 509 is an interface for data communication via a communication network. The data bus 510 includes an address bus and a data bus that electrically connect components such as the CPU 501 illustrated in FIG. 3 to each other.

The keyboard 511 is an example of an input device including a plurality of keys for inputting, for example, characters, numerical values, and various instructions. The pointing device 512 is an example of an input device that allows the user to select or execute various instructions, select an object to be processed, and move a cursor being displayed. The DVD-RW drive 514 controls reading and writing of various data from and to a DVD-RW 513, which is an example of a detachable recording medium. The DVD-RW drive 514 may control reading and writing of various data from and to a DVD-R without limiting to the DVD-RW. The medium I/F 516 controls reading and writing (storing) of data from and to a recording medium 515 such as a flash memory.

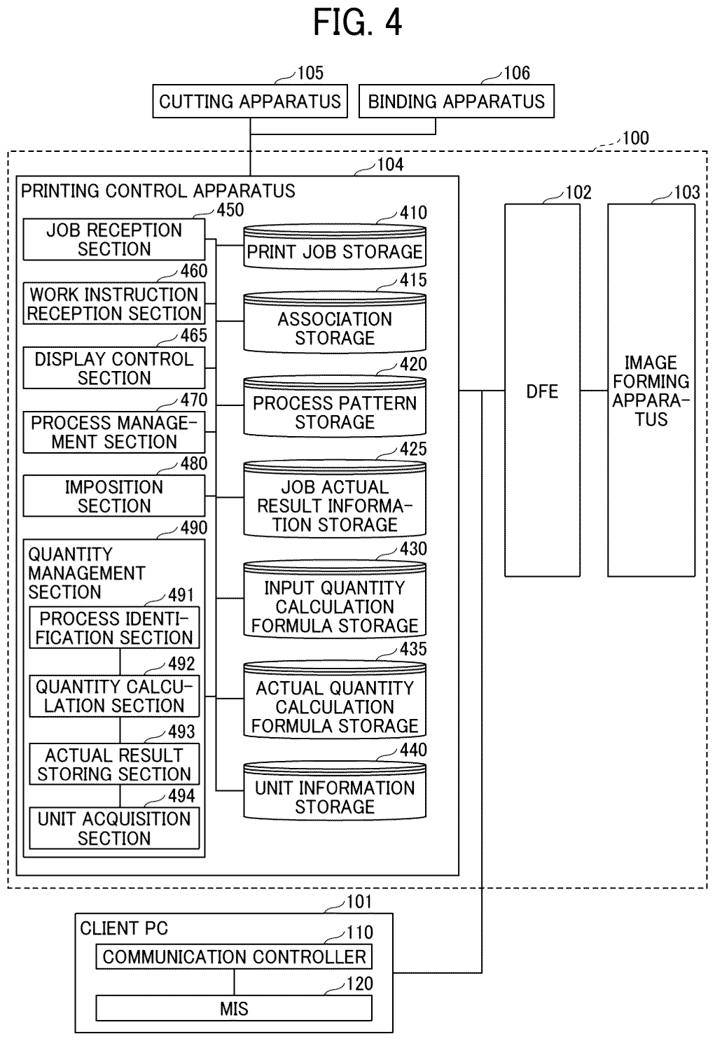

Hardware configurations of the client PC 101 and the DFE 102 according to the present embodiment may be similar to the configuration of the printing control apparatus 104. Functions of the printing control apparatus 104 and the client PC 101 according to the present embodiment are described with reference to FIG. 4. FIG. 4 is a diagram for describing functional configurations of the printing control apparatus 104 and the client PC 101.

The function of the client PC 101 is described below. The function of the client PC 101 is implemented by a CPU of the client PC 101 reading and executing a program stored in, for example, a storage of the client PC 101.

The client PC 101 according to the present embodiment includes a communication controller 110 and a management information system (MIS) 120. The communication controller 110 controls communication between the client PC 101 and external apparatuses such as the printing control apparatus 104.

The MIS 120 is an application that manages information useful for business decision and extracts and summarizes such accumulated information. Specifically, the MIS 120 mainly performs single-item profit and loss calculation. In the single-item profit and loss calculation, the MIS 120 calculates a profit by subtracting the cost relating to the production (such as the cost derived from actual quantity information in each process) from the planned sales amount derived from processes identified from a print job. In the example of FIG. 4, the client PC 101 includes the MIS 120. In another example, the printing control apparatus 104 may include the MIS 120.

The function of the printing control apparatus 104 is described below. The printing control apparatus 104 according to the present embodiment includes a print job storage section 410, an association storage section 415, a process pattern storage section 420, a job actual result information storage section 425, an input quantity calculation formula storage section 430, an actual quantity calculation formula storage section 435, and a unit information storage section 440. Each of these storage sections may be implemented using, for example, the HD 504 under control of a processor such as the CPU 501. For simplicity, the term “section” is omitted in figures.

The printing control apparatus 104 includes a job reception section 450, a work instruction reception section 460, a display control section 465, a process management section 470, an imposition section 480, and a quantity management section 490. Each of the job reception section 450, the work instruction reception section 460, the display control section 465, the process management section 470, the imposition section 480, and the quantity management section 490 may be implemented by the CPU 501 reading and executing a program (application) stored in a storage such as the ROM 502, the RAM 503, or the HD 504.

The print job storage section 410 stores a print job that has been input to the printing control apparatus 104. The association storage section 415 stores association information in which a print job is associated with a process pattern. The process pattern storage section 420 stores process pattern information indicating a process pattern. The process pattern information according to the present embodiment is synonymous with a digital workflow.

The job actual result information storage section 425 stores information for managing, for example, the progress of a print job. Specifically, the job actual result information storage section 425 stores, for each process, information including the planned input quantity, the input quantity, the planned actual quantity, and the actual quantity in association with a print job.

The input quantity calculation formula storage section 430 stores, for each process, input quantity calculation formula information including a calculation formula for calculating the planned input quantity. The actual quantity calculation formula storage section 435 stores, for each process, actual quantity calculation formula information including an actual quantity calculation formula for calculating the planned actual quantity. The unit information storage section 440 stores unit information indicating the unit of the quantity for each process. Each storage section will be described in detail later.

The job reception section 450 receives an input of a print job from the client PC 101. When the print job is input, the job reception section 450 stores the input print job in the print job storage section 410. The client PC 101 is an example of an input source that inputs a print job to the printing control apparatus 104.

The work instruction reception section 460 receives an input of a work instruction that instructs the printing control apparatus 104 to execute a print job. The work instruction reception section 460 instructs the process management section 470 to execute a print job. When the work instruction reception section 460 receives a work instruction, the work instruction reception section 460 may also receive a change in the processing content of any process from the user of the printing control apparatus 104. When the processing content is changed, the work instruction reception section 460 instructs the process management section 470 to execute the print job based on the changed processing content. A change in the processing content includes a change in the printing condition.

The display control section 465 controls the display on the display 506 of the printing control apparatus 104. Specifically, the display control section 465 may display, on the display 506, a list of print jobs stored in the print job storage section 410. The display control section 465 may also display, on the display 506, an operation screen for changing a printing condition included in a print job.

The process management section 470 is implemented by the process management application installed in the printing control apparatus 104. The process management section 470 manages each process to be executed in the printing system 100. Specifically, the process management section 470 causes each process included in a digital workflow to be executed in response to the reception of a work instruction that instructs the execution of a print job. When the process management section 470 receives the work instruction for the print job, the process management section 470 provides work instruction information indicating the work content based on the print job to the quantity management section 490.

The process management section 470 acquires the quantities indicating the results of executing the processes from the applications or apparatuses that have executed the respective processes and outputs the acquired quantities to the MIS 120 of the client PC 101.

In this way, in the present embodiment, the printing control apparatus 104 notifies the MIS 120 of the progress of the print job for each process.

The function of the process management section 470 may vary for each commercial printing company. The process management section 470 generates position information relating to finishing and provides the position information to the imposition section 480. The finishing according to the present embodiment includes, for example, cutting by the cutting apparatus 105 and binding by the binding apparatus 106. In other words, finishing may refer to the cutting process or the binding process that is executed after the printing process is executed. The imposition section 480 may generate the position information relating to finishing. When the imposition section 480 generates the position information, the imposition section 480 provides the generated position information to the process management section 470

The imposition section 480 is implemented by the imposition application installed in the printing control apparatus 104. The imposition section 480 performs imposition relating to printing. Imposition refers to a process of arranging pages on a sheet so that when the sheet is folded in accordance with a predetermined procedure, the pages appear on the sheet in the correct order.

The quantity management section 490 according to the present embodiment includes a process identification section 491, a quantity calculation section 492, an actual result storing section 493, and a unit acquisition section 494.

When the job reception section 450 receives the input of a print job, the process identification section 491 refers to the process pattern storage section 420 to identify process pattern information according to the type of printed matter (product) and the number of copies imposed per sheet that are included in the printing condition indicated by the print job. In other words, the process identification section 491 identifies a process pattern corresponding to the print job according to the printing condition. When the process identification section 491 identifies the process pattern information, the process identification section 491 stores, in the association storage section 415, association information in which the identified process pattern information is associated with the print job.

In the present embodiment, the process pattern information is identified according to the printing condition included in the print job. This configuration eliminates the need for the user of the printing control apparatus 104 to manually set the process pattern, thereby saving time and effort.

The quantity calculation section 492 refers to the input quantity calculation formula storage section 430 to calculate the planned input quantity for each process included in the identified process pattern. The planned input quantity calculated for each process indicates the quantity which is determined according to the quantity included in the printing condition and which is planned to be input to the corresponding processing apparatus or application that executes the process according to the work instruction for the print job.

The quantity calculation section 492 refers to the actual quantity calculation formula storage section 435 to calculate the planned actual quantity for each process. The planned actual quantity calculated for each process indicates the quantity which is determined according to the quantity included in the printing condition and which is planned to be output from the corresponding processing apparatus or application that executes the process when the print job is executed according to the work instruction for the print job.

The quantity calculation section 492 stores the calculated planned input quantity and planned actual quantity for each process of the print job in the job actual result information storage section 425.

Specifically, the planned input quantity and the planned actual quantity are stored in association with the print job and each process included in the process pattern corresponding to the print job.

More specifically, the quantity calculation section 492 calculates, for each process indicated by the identified process pattern information, the planned input quantity and the planned actual quantity as quantities associated with the print job based on the quantity included in the printing condition.

The actual result storing section 493 acquires, for each process, the input quantity that has been actually input to the corresponding processing apparatus or application that executes the process. The actual result storing section 493 also acquires, for each process, the actual quantity that has been actually output from the corresponding processing apparatus or application that executes the process.

The actual result storing section 493 according to the present embodiment acquires the input quantity and the actual quantity and then stores the input quantity and the actual quantity in the job actual result information storage section 425 for each process of the print job. Specifically, the input quantity and the actual quantity are stored in association with the print job, a corresponding one of the processes included in the process pattern associated with the print job, and the corresponding planned input quantity and planned actual quantity.

The unit acquisition section 494 refers to the unit information storage section 440 to acquire information indicating the unit of the quantity for each process included in the process pattern identified by the process identification section 491. Specifically, the unit acquisition section 494 acquires unit information indicating the unit of the actual quantity for each process.

In this way, the quantity management section 490 according to the present embodiment causes the printing control apparatus 104 to store, for each process included in the process pattern corresponding to the print job, the planned input quantity and the planned actual quantity based on the print job and the input quantity and the actual quantity when the print job is actually executed, in association with the unit of the actual quantity.

Accordingly, the configuration according to the present embodiment allows the client PC 101 to recognize, for each process, whether or not the processing indicated by the print job has been executed as planned or whether or not the processing content has been changed in the process pattern corresponding to the print job.

According to the present embodiment, the quantity management section 490 manages the quantity and the unit of the quantity in association with each other for each process included in the process pattern corresponding to the print job, so that the quantity and the unit are managed in association with each other for each process.

All or part of the storage sections of the printing control apparatus 104 may be provided in, for example, an external storage that is communicable with the printing control apparatus 104. The printing control apparatus 104 may also be implemented by a plurality of information processing apparatuses.

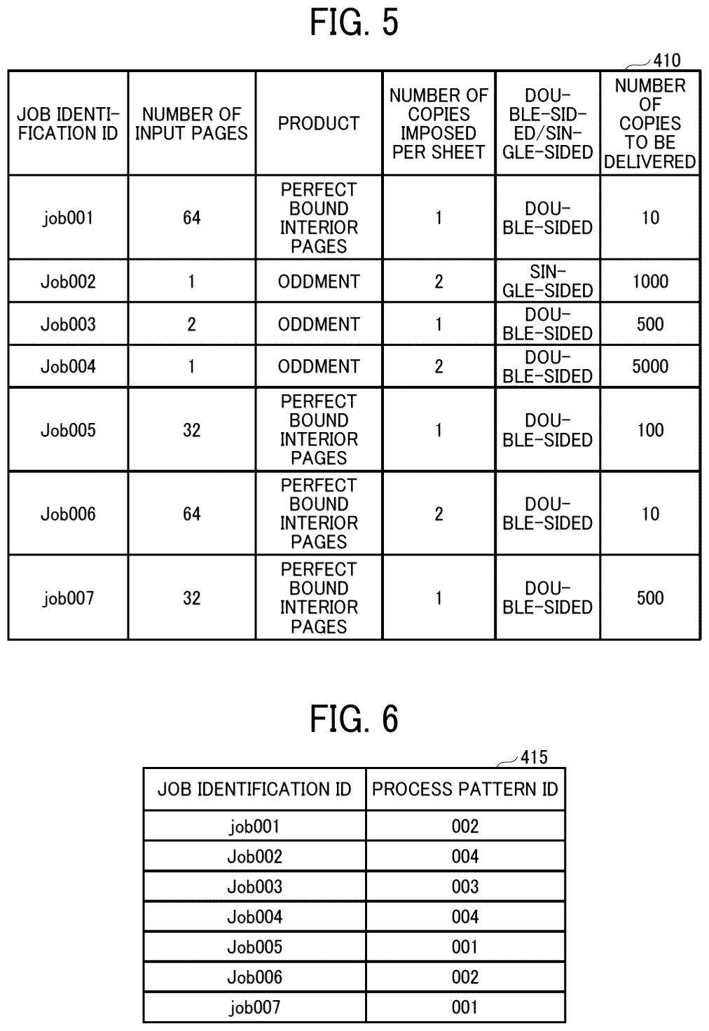

Each storage section of the printing control apparatus 104 is described below with reference to FIGS. 5 to 12.

FIG. 5 is a table illustrating an example of the print job storage section 410. Each print job stored in the print job storage section 410 includes, as items of information, “job identification ID,” “the number of input pages,” “product,” “the number of copies imposed per sheet,” “double-sided/single-sided,” and “the number of copies to be delivered.” The item “job identification ID” is associated with the other items in the print job storage section 410.

A value of the item “job identification ID” indicates identification information for identifying a print job. A value of the item “the number of input pages” indicates the number of pages of the printed matter in the content data included in the print job. The content data according to the present embodiment may be data in a PDF format, and the number of input pages may be the number of pages of the data in the PDF format.

A value of the item “product” indicates the type of printed matter. A value of the item “the number of copies imposed per sheet” indicates the number of copies included in a single sheet. Specifically, for example, assume a case where the value of the item “the number of copies imposed per sheet” is “2.” This indicates that two copies are printed on a single signature. Although signature refers to a printed sheet of paper folded such that pages appear in a correct order, the signature is not necessarily folded.

A value of the item “double-sided/single-sided” indicates whether to perform double-sided printing or single-sided printing. A value of the item “the number of copies to be delivered” indicates the number of copies of the printed matter to be delivered as a product by, for example, a printing company using the image forming apparatus 103.

In the present embodiment, for example, the items “the number of copies imposed per sheet,” “double-sided/single-sided,” and “the number of copies to be delivered” included in a print job are included in the printing condition.

In the example of FIG. 5, for example, the print job identified by the job identification ID “job001” indicates that the number of pages of the input content data is 64 pages and the 64 interior pages are printed double-sided with the number of copies imposed per sheet being one to create 10 perfect bound booklets.

FIG. 5 illustrates merely an example of a print job and the items of information included in the print job are not limited to the items illustrated in FIG. 5.

FIG. 6 is a table illustrating an example of the association storage section 415. The association information stored in the association storage section 415 includes “job identification ID” and “process pattern ID” as items of information. The job identification ID and the process pattern ID are associated with each other. A value of the item “process pattern ID” indicates identification information for identifying the process pattern information (digital workflow).

The association information according to the present embodiment is stored each time a print job is executed. In the example of FIG. 6, the print job identified by the job identification ID “job001” is associated with the process pattern information identified by the process pattern ID “002.”

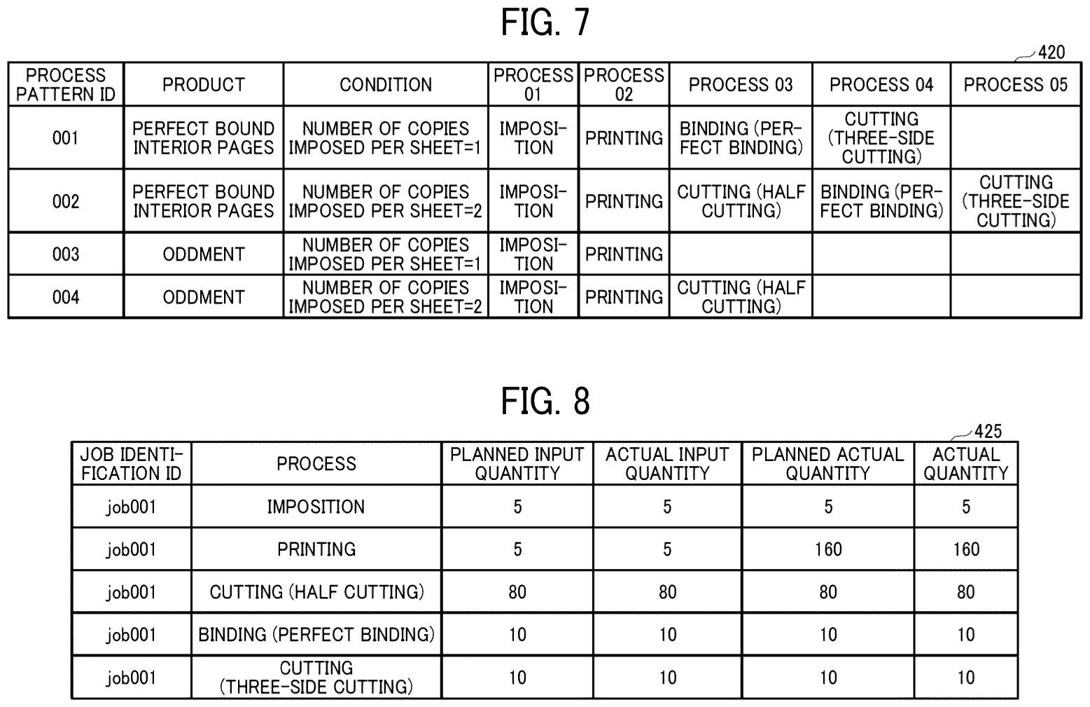

FIG. 7 is a table illustrating an example of the process pattern storage section 420. The process pattern information stored in the process pattern storage section 420 includes “process pattern ID,” “product,” “condition,” and “process 01” to “process 05” as the items of information. The item “process pattern ID” is associated with the other items. The process pattern information according to the present embodiment is stored in the printing control apparatus 104 in advance.

In the example of FIG. 7, the process pattern information associated with the process pattern ID “001” indicates that the type of printed matter is “perfect bound interior pages,” the number of copies imposed per sheet is “1,” the process 01 is “imposition,” the process 02 is “printing,” the process 03 is “binding (perfect binding),” and the process 04 is “cutting (three-side cutting).” In the example of FIG. 7, the process pattern information associated with the process pattern ID “002” indicates that the type of printed matter is “perfect bound interior pages,” the number of copies imposed per sheet is “2,” the process 01 is “imposition,” the process 02 is “printing,” the process 03 is “cutting (half cutting),” the process 04 is “binding (perfect binding),” and the process 05 is “cutting (three-side cutting).”

FIG. 8 is a table illustrating an example of the job actual result information storage section 425. The job actual result information stored in the job actual result information storage section 425 includes, as items of information, “job identification ID,” “process,” “planned input quantity,” “actual input quantity,” “planned actual quantity,” and “actual quantity.” The job actual result information is stored in the job actual result information storage section 425 each time a print job is executed.

A value of the item “process” indicates a process included in the process pattern information that is associated with the job identification ID. A value of the item “planned input quantity” indicates the input quantity planned to be input to the corresponding processing apparatus or application that executes the process indicated by the value of the item “process.”

A value of the item “actual input quantity” indicates the quantity actually input to the corresponding processing apparatus or application that executes the process indicated by the value of the item “process.” Unless the processing content is changed, the input quantity is equal to the planned input quantity.

A value of the item “planned actual quantity” indicates the quantity planned to be output from the corresponding processing apparatus or application when the processing apparatus or application that executes the process indicated by the value of the item “process” has executed processing based on the print job.

A value of the item “actual quantity” indicates the quantity actually output from the corresponding processing apparatus or application that has executed the process indicated by the value of the item “process.” Unless the processing content is changed, the actual quantity is equal to the planned actual quantity.

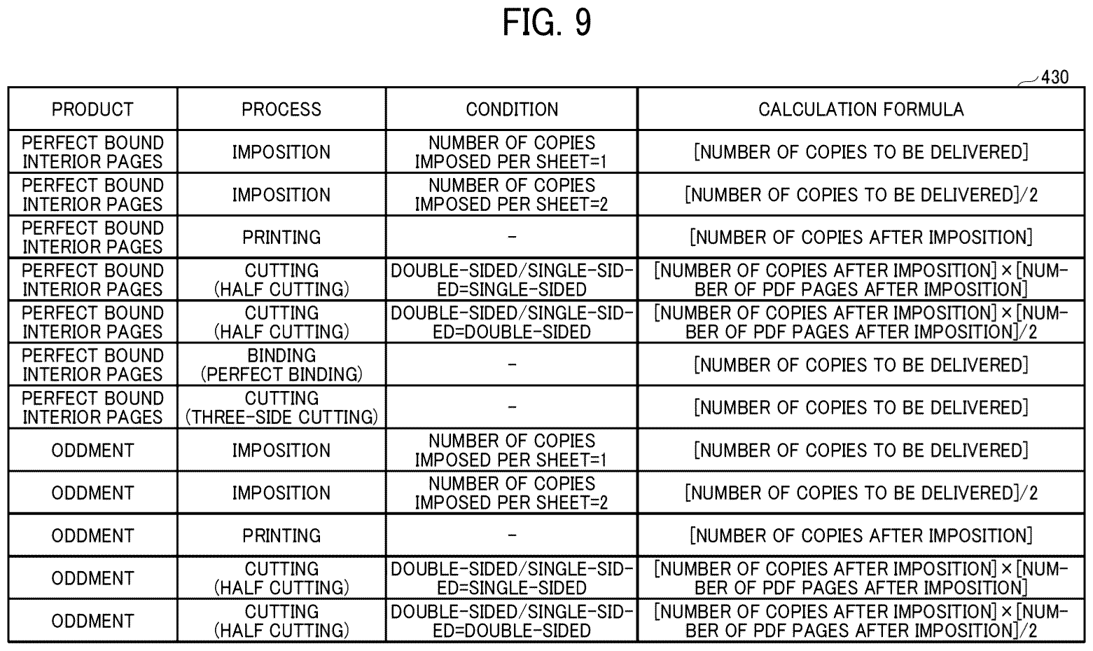

FIG. 9 is a table illustrating an example of the input quantity calculation formula storage section 430. The input quantity calculation formula information stored in the input quantity calculation formula storage section 430 includes, as items of information, “product,” “process,” “condition,” and “calculation formula.” The item “calculation formula” is associated with each combination of the items “product,” “process,” and “condition.” The input quantity calculation formula information illustrated in FIG. 9 is stored in the input quantity calculation formula storage section 430 in advance.

In the input quantity calculation formula storage section 430, a value of the item “condition” indicates the processing condition corresponding to the process indicated by the value of the item “process.” A value of the item “calculation formula” indicates the calculation formula for calculating the planned input quantity for the process indicated by the value of the item “process.” When the condition indicated by the value of the item “condition” is set, the calculation formula is applied in the set condition. When the condition indicated by the value of the item “condition” is not set, the calculation formula is applied in any condition.

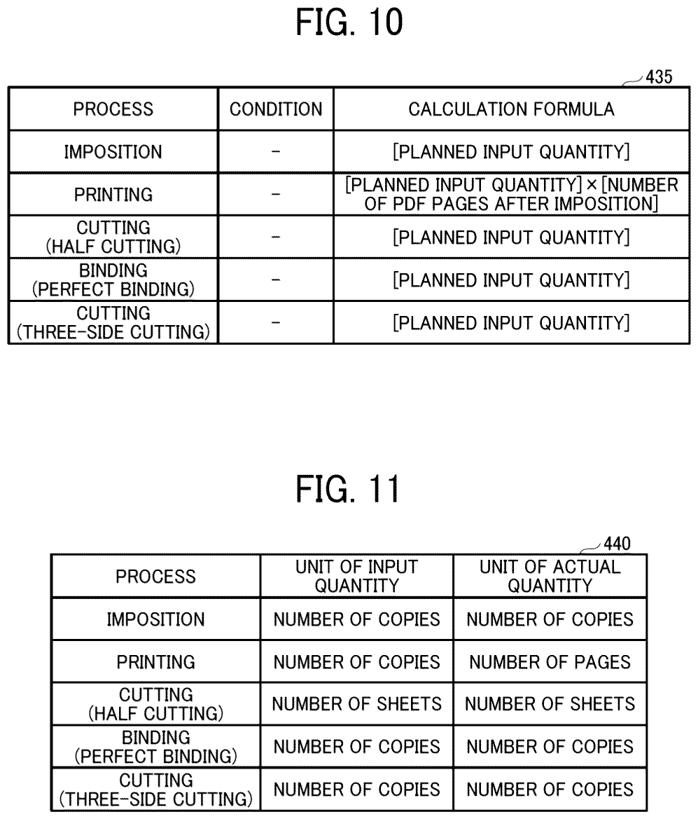

In the example of FIG. 9, when the type of printed matter is “perfect bound interior pages” and the number of copies imposed per sheet is set to “1,” the planned input quantity in the process “imposition” is equal to “the number of copies to be delivered” included in the print job. FIG. 10 is a table illustrating an example of the actual quantity calculation formula storage section 435. The actual quantity calculation formula information stored in the actual quantity calculation formula storage section 435 includes “process,” “condition,” and “calculation formula” as the items of information. The item “calculation formula” is associated with each of the items “process” and “condition.” The actual quantity calculation formula information illustrated in FIG. 10 is stored in the actual quantity calculation formula storage section 435 in advance.

In the actual quantity calculation formula storage section 435, a value of the item “calculation formula” indicates the calculation formula for calculating the planned actual quantity for the process indicated by the value of the item “process.” When the condition indicated by the value of the item “condition” is set, the calculation formula is applied in the set condition. When the condition indicated by the value of the item “condition” is not set, the calculation formula is applied in any condition.

In the example of FIG. 10, the planned actual quantity for the process “printing” is the planned input quantity × the number of pages after imposition.

FIG. 11 is a table illustrating an example of the unit information storage section 440. The unit information storage section 440 according to the present embodiment includes “process,” “unit of input quantity,” and “unit of actual quantity” as the items of information. The items “process,” “unit of input quantity,” and “unit of actual quantity” are associated with each other in the unit information storage section 440. The unit information illustrated in FIG. 11 is stored in the unit information storage section 440 in advance.

A value of the item “unit of input quantity” indicates the unit of the planned input quantity and the input quantity. A value of the item “unit of actual quantity” indicates the unit of the planned actual quantity and the actual quantity.

In the example of FIG. 11, for example, the unit of the planned input quantity and the input quantity for the process “printing” is “the number of copies,” and the unit of the planned actual quantity and the actual quantity for the process “printing” is “the number of pages.”

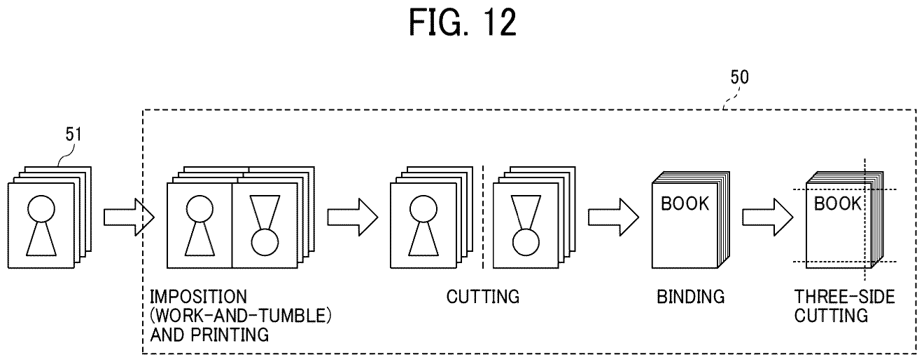

An example of a process pattern is described with reference to FIG. 12. FIG. 12 is a diagram illustrating an example of the process pattern.

A process pattern 50 illustrated in FIG. 12 illustrates a process pattern indicated by the process pattern information identified by the process pattern ID “002.”

The process pattern 50 includes the process 01 “imposition,” the process 02 “printing,” the process 03 “cutting (half cutting),” the process 04 “binding (perfect binding),” and the process 05 “cutting (three-side cutting)” (see FIG. 7). Therefore, when a print job including input content data 51 is associated with the process pattern ID “002,” the printing control apparatus 104 executes each of these processes included in the process pattern 50.

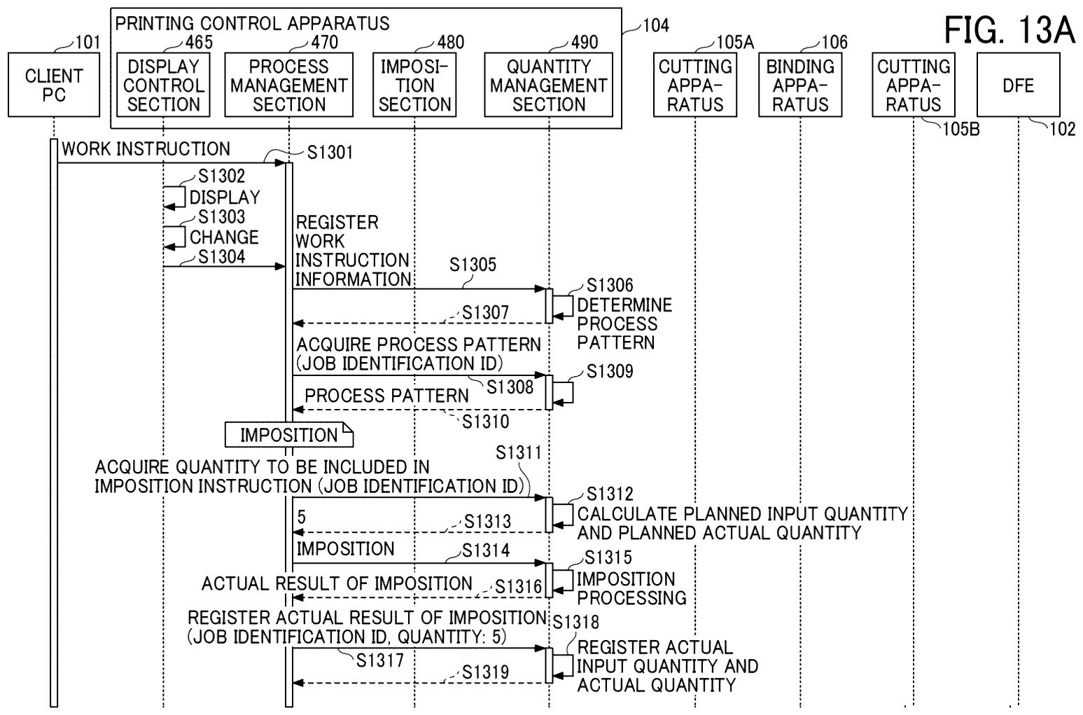

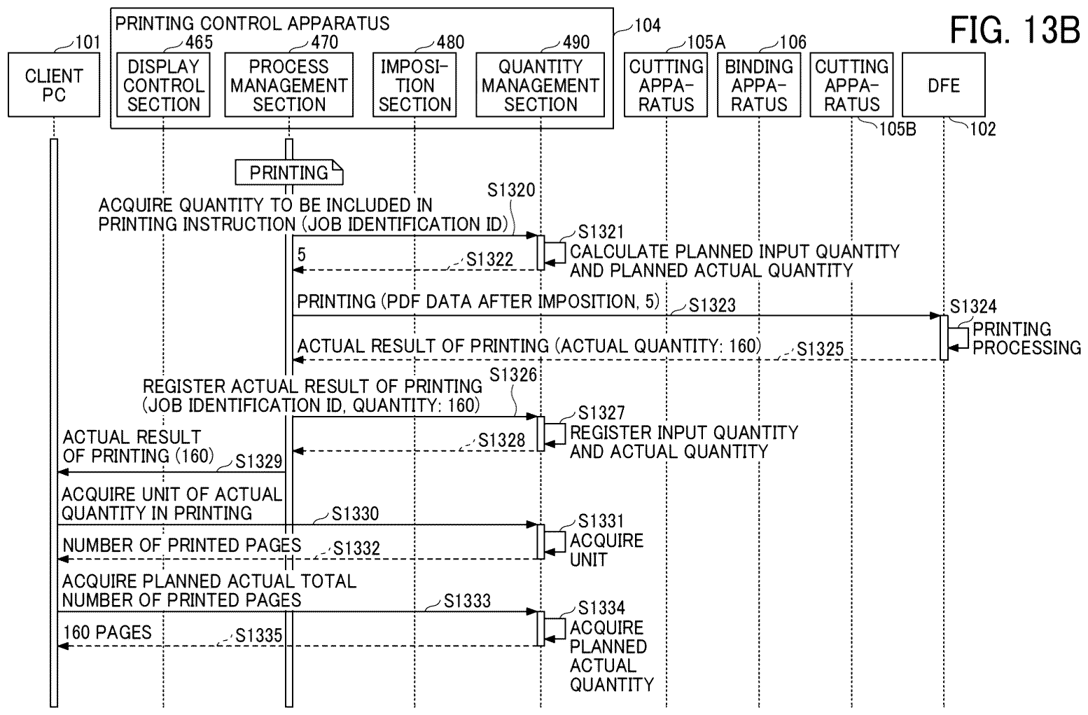

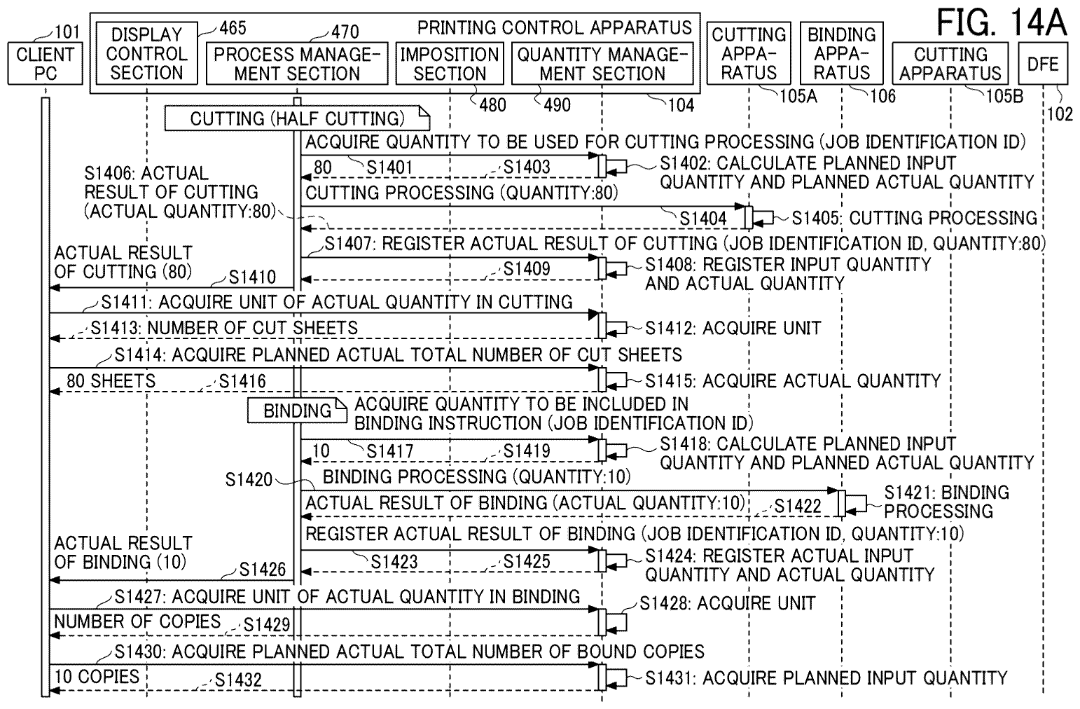

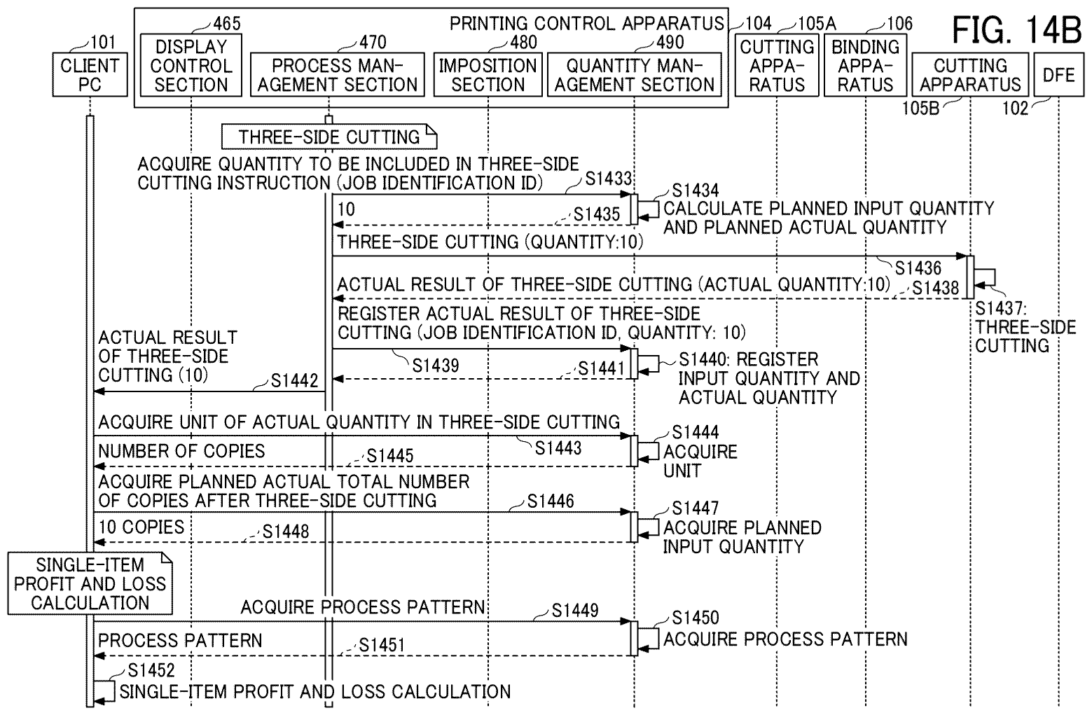

An operation of the printing system 100 is described with reference to FIGS. 13A, 13B, 14A, and 14B. FIGS. 13A, 13B, 14A, and 14B illustrate an operation of the printing system 100 when a work instruction for the print job identified by the job identification ID “job001” is input to the printing control apparatus 104.

FIG. 13A is a first sequence diagram illustrating the operation of the printing system 100. In the printing system 100, in step S1301, the work instruction reception section 460 of the printing control apparatus 104 receives a work instruction for a print job from the client PC 101. This work instruction includes the job identification ID that identifies the print job. In this case, the work instruction includes the job identification ID “job001.”

In step S1302, when the printing control apparatus 104 receives the work instruction for the print job, the display control section 465 displays a screen on which the user is allowed to change the printing condition for the print job for which the printing control apparatus 104 has received the work instruction. In step S1303, the printing control apparatus 104 receives a change in the printing condition. The change in the printing condition indicates a change in the processing content of a process.

The printing condition included in the print job identified by the job identification ID “job001” includes “perfect bound interior pages, the number of copies imposed per sheet is 1, double-sided printing, and the number of copies to be delivered is 10” (see FIG. 5).

In the example of FIG. 13A, it is assumed in step S1303 that the user has performed an operation of changing the printing condition to “perfect bound interior pages, the number of copies imposed per sheet is 2, double-sided printing, and the number of copies to be delivered is 10.”

In the present embodiment, when the printing control apparatus 104 receives the work instruction for the print job, the display control section 465 displays the screen on which the user is allowed to change the printing condition for the print job. However, the present disclosure is not limited thereto. The display control section 465 may not display the screen on which the user is allowed to change the printing condition.

In the printing control apparatus 104, in step S1304, after the display control section 465 receives the change, the display control section 465 provides the work instruction including the changed printing condition to the process management section 470.

In step S1305, the process management section 470 causes the quantity management section 490 to register the work instruction information corresponding to the print job for which the work instruction has been given.

In this case, the job identification ID “job001” and the printing condition indicating “perfect bound interior pages, the number of copies imposed per sheet is 2, double-sided printing, and the number of copies to be delivered is 10” is registered in the quantity management section 490 as the work instruction information.

In step S1306, the process identification section 491 of the quantity management section 490 refers to the process pattern storage section 420 to identify the process pattern ID based on the type of printed matter and the number of copies imposed per sheet which are indicated by the print job. In step S1307, the process identification section 491 provides the identified process pattern ID to the process management section 470.

In this example, the type of printed matter (product) is “perfect bound interior pages” and the number of copies imposed per sheet is “2.” Therefore, the process identification section 491 identifies, from the process pattern storage section 420, the process pattern ID “002” where the product is “perfect bound interior pages” and the condition is “the number of copies imposed per sheet is 2.” In other words, in the present embodiment, the process identification section 491 identifies the process pattern ID based on a combination of the item “product” and the item “condition” in the process pattern storage section 420.

In step S1308, the process management section 470 requests the quantity management section 490 to acquire the process pattern information. In step S1309, the quantity management section 490 acquires the process pattern information corresponding to the process pattern ID “002” identified by the process identification section 491 from the process pattern storage section 420. In step S1310, the quantity management section 490 provides the acquired process pattern information to the process management section 470.

Next, the process management section 470 sequentially executes the processes indicated by the process pattern information. First, the process management section 470 executes the imposition process.

In step S1311, the process management section 470 requests the quantity management section 490 to acquire the quantity to be included in an imposition instruction to the imposition section 480. Specifically, the process management section 470 requests the quantity management section 490 to acquire the planned input quantity to be input to the imposition section 480. This request includes the job identification ID.

In step S1312, the quantity management section 490 receives this request and causes the quantity calculation section 492 to calculate the planned input quantity and the planned actual quantity in the imposition process and store the planned input quantity and the planned actual quantity in association with the job identification ID in the job actual result information storage section 425.

Specifically, the quantity calculation section 492 calculates the planned input quantity based on the calculation formula “the number of copies to be delivered/2” identified from the product “perfect bound interior pages,” the condition “the number of copies imposed per sheet is 2,” and the process “imposition” in the input quantity calculation formula storage section 430. In this example, since the number of copies to be delivered is “10,” the planned input quantity is “5.”

The quantity calculation section 492 calculates the planned actual quantity using the calculation formula identified from the item “imposition” in the actual quantity calculation formula storage section 435. In this example, since the planned actual quantity is equal to the planned input quantity, the planned actual quantity is “5.”

In step S1313, the quantity management section 490 provides the planned input quantity to the process management section 470.

In step S1314, the process management section 470 requests the imposition section 480 to execute the imposition process. This request includes “the number of copies imposed per sheet is 2,” “the input content data 51,” and “the planned input quantity is 5.”

The imposition section 480 executes the imposition process in step S1315 and provides the execution result to the process management section 470 in step S1316. The execution result includes the input content data 51 subjected to the imposition and the actual quantity in the imposition process. The execution result may also include the input quantity input to the imposition section 480.

In the example of FIG. 13A, since a change in the processing content of the imposition process is not received, the input quantity and the actual quantity in the imposition process are “5” which is the same quantity as the planned input quantity and the planned actual quantity.

In step S1317, the process management section 470 receives the execution result and requests the quantity management section 490 to register the actual quantity in the imposition process. This request includes the job identification ID “job001” and the input quantity of “5” and the actual quantity of “5” acquired in step S1316.

In step S1318, the quantity management section 490 receives this request and causes the actual result storing section 493 to store the input quantity and the actual quantity in association with the job identification ID in the job actual result information storage section 425.

In the job actual result information storage section 425 according to the present embodiment, the planned input quantity, the input quantity, the planned actual quantity, and the actual quantity in the imposition process are stored in association with each other.

In the present embodiment, the planned actual quantity and the input quantity are stored in association with each other in the job actual result information storage section 425. Therefore, when the planned actual quantity is changed before the printing process, the change is detectable.

In the present embodiment, the planned actual quantity and the actual quantity are stored in association with each other in the job actual result information storage section 425. Therefore, after the printing process, whether or not the processing has been executed as indicated by the print job is detectable. The detection result may be displayed on the display 506 of the printing control apparatus 104 in response to, for example, the operation by the user of the printing control apparatus 104. In step S1319, when the actual result storing section 493 has completed storing the input quantity and the actual quantity, the quantity management section 490 notifies the process management section 470 of the completion of the storage.

The printing system 100 according to the present embodiment executes the above-described processing according to the identified process pattern.

The operation of the printing system 100 in the printing process that is executed after the imposition process is described below with reference to FIG. 13B. FIG. 13B is a second sequence diagram for describing the operation of the printing system 100.

In the printing system 100, in step S1320, the process management section 470 of the printing control apparatus 104 requests the quantity management section 490 to acquire the quantity to be included in a printing instruction to the image forming apparatus 103. Specifically, the process management section 470 requests the quantity management section 490 to acquire the planned input quantity to be input to the DFE 102. This request includes the job identification ID.

In step S1321, the quantity management section 490 receives this request and causes the quantity calculation section 492 to calculate the planned input quantity and the planned actual quantity in the printing process and store the planned input quantity and the planned actual quantity in association with the job identification ID in the job actual result information storage section 425.

Specifically, the quantity calculation section 492 calculates the planned input quantity based on the calculation formula identified from the product “perfect bound interior pages” and the process “printing” in the input quantity calculation formula storage section 430. In this example, the planned input quantity is equal to the number of copies after imposition. Therefore, the quantity calculation section 492 acquires, as the planned input quantity, the actual quantity of “5” in the imposition process that is stored in the job actual result information storage section 425.

The quantity calculation section 492 calculates the planned actual quantity using the calculation formula identified from the item “printing” in the actual quantity calculation formula storage section 435. In this case, the planned actual quantity is calculated using the calculation formula “planned input quantity × the number of pages of the input content data after imposition.” Since the number of pages of the input content data after imposition is “64/2,” which is “32.” Therefore, the planned actual quantity is “5×32,” which is “160.”

In step S1322, the quantity management section 490 provides the planned input quantity to the process management section 470.

In step S1323, the process management section 470 requests the DFE 102 to execute the printing process. This request includes the input content data 51 after imposition and the planned input quantity of “5.”

The DFE 102 causes the image forming apparatus 103 to execute the printing processing in step S1324 and provides the execution result to the process management section 470 in step S1325. In this example, the execution result includes the actual quantity which is the result of printing actually executed by the image forming apparatus 103. The execution result may also include the input quantity actually input to the DFE 102. The execution result may also include identification information for identifying the DFE 102 or the image forming apparatus 103. In other words, the execution result of the printing process may include the apparatus ID for identifying the apparatus that has executed the processing.

In the example of FIG. 13B, since a change in the processing content of the printing process is not received, the input quantity and the actual quantity in the printing process are equal to the planned input quantity and the planned actual quantity. In other words, the actual quantity acquired in step S1325 is “160” which is the same quantity as the planned actual quantity.

In step S1326, the process management section 470 receives the execution result and requests the quantity management section 490 to register the actual quantity in the printing process. This request includes the job identification ID “job001” and the input quantity of “5” and the actual quantity of “160” acquired in step S1325.

In step S1327, the quantity management section 490 receives this request and causes the actual result storing section 493 to store the input quantity and the actual quantity in association with the job identification ID in the job actual result information storage section 425. In step S1328, when the actual result storing section 493 has completed storing the input quantity and the actual quantity, the quantity management section 490 notifies the process management section 470 of the completion of the storage.

In step S1329, the process management section 470 notifies the MIS 120 of the client PC 101 of the actual quantity of “160” in the printing process.

In step S1330, the MIS 120 transmits a request to the quantity management section 490 of the printing control apparatus 104 to acquire the unit information indicating the unit of the actual quantity of “160.” In step S1331, the quantity management section 490 receives this acquisition request and causes the unit acquisition section 494 to refer to the unit information storage section 440 to acquire the unit information indicating the unit of the actual quantity in the printing process. In this example, the unit acquisition section 494 acquires “the number of pages” as the unit information of the actual quantity in the printing process.

In step S1332, the unit acquisition section 494 transmits the acquired unit information to the MIS 120. In other words, the unit acquisition section 494 transmits the unit information “the number of pages” to the MIS 120. In step S1333, the MIS 120 transmits a request to the quantity management section 490 of the printing control apparatus 104 to acquire the planned actual quantity in the printing process.

In step S1334, the quantity management section 490 receives this acquisition request and refers to the job actual result information storage section 425 to acquire the planned actual quantity in the printing process. In step S1335, the quantity management section 490 transmits the planned actual quantity to the MIS 120. In this example, since the planned actual quantity in the printing process is “160,” the quantity management section 490 transmits the planned actual quantity of “160” to the MIS 120.

In the present embodiment, the printing control apparatus 104 transmits the planned actual quantity and the actual quantity in the printing process to the client PC 101 in this way.

Specifically, in the present embodiment, the printing control apparatus 104 provides information indicating “printing process, the number of pages planned to be printed, and the number of pages actually printed” to the client PC 101.

This configuration allows the MIS 120 of the client PC 101 to compare the planned actual quantity and the actual quantity in the printing process.

In the present embodiment, the planned actual quantity and the actual quantity when the printing process is completed are both “160” pages. Therefore, the MIS 120 recognizes that the actual printing has been executed in accordance with the planned number of pages indicated by the print job.

The MIS 120 acquires the quantity and the unit of the quantity output from the process management section 470. In the present embodiment, therefore, the MIS 120 is notified of which process the actual quantity acquired by the MIS 120 is for and what unit the quantity is in.

The cutting process (half cutting) and the binding process which are executed after the printing process are described with reference to FIG. 14A. FIG. 14A is a third sequence diagram for describing the operation of the printing system 100.

In the printing system 100, in step S1401, the process management section 470 of the printing control apparatus 104 requests the quantity management section 490 to acquire the quantity to be included in a cutting instruction to a cutting apparatus 105A. Specifically, the process management section 470 requests the quantity management section 490 to acquire the planned input quantity to be input to the cutting apparatus 105A. This request includes the job identification ID. The cutting apparatus 105A is an example of a processing apparatus that cuts sheets in half.

In step S1402, the quantity management section 490 receives this request and causes the quantity calculation section 492 to calculate the planned input quantity and the planned actual quantity in the cutting (half cutting) process and store the calculated planned input quantity and planned actual quantity in association with the job identification ID in the job actual result information storage section 425.

Specifically, the quantity calculation section 492 calculates the planned input quantity based on the calculation formula identified from the product “perfect bound interior pages,” the process “cutting (half cutting),” and the condition “double-sided” in the input quantity calculation formula storage section 430. The calculation formula identified herein is “the number of copies after imposition×the number of pages of the input content data 51 after imposition/2.” Therefore, the quantity calculation section 492 acquires, as the planned input quantity, “80” which is the calculation result of “(5×32)/2.” In this example, the planned input quantity indicates the number of sheets after the sheets are cut in half.

The quantity calculation section 492 calculates the planned actual quantity using the calculation formula identified from the item “cutting (half cutting)” in the actual quantity calculation formula storage section 435. In this example, since the planned actual quantity is equal to the planned input quantity, the quantity calculation section 492 acquires the planned input quantity of “80” as the planned actual quantity.

In step S1403, the quantity management section 490 provides the planned input quantity to the process management section 470.

In step S1404, the process management section 470 requests the cutting apparatus 105A to execute the cutting (half cutting) process. This request includes the planned input quantity of “80.”

The cutting apparatus 105A executes the cutting process in step S1405 and provides the execution result to the process management section 470 in step S1406. In this example, the execution result includes the number of sheets cut by the cutting apparatus 105A. The execution result may also include the input quantity actually input to the cutting apparatus 105A. The execution result may also include identification information for identifying the cutting apparatus 105A. In other words, the execution result of the cutting (half cutting) process may include the apparatus ID for identifying the apparatus that has executed the cutting (half cutting) process.

In the example of FIG. 14A, since a change in the processing content of the cutting (half cutting) process is not received, the input quantity and the actual quantity in the cutting (half cutting) process are “80” which is the same quantity as the planned input quantity and the planned actual quantity.

In step S1407, the process management section 470 receives the execution result and requests the quantity management section 490 to register the actual quantity in the cutting (half cutting) process. This request includes the job identification ID “job001” and the input quantity of “80” and the actual quantity of “80” acquired in step S1406.

In step S1408, the quantity management section 490 receives this request and causes the actual result storing section 493 to store the input quantity and the actual quantity in association with the job identification ID in the job actual result information storage section 425. In step S1409, when the actual result storing section 493 has completed storing the input quantity and the actual quantity, the quantity management section 490 notifies the process management section 470 of the completion of the storage.

In step S1410, the process management section 470 notifies the MIS 120 of the client PC 101 of the actual quantity of “80” in the cutting (half cutting) process.

In step S1411, the MIS 120 transmits a request to the quantity management section 490 of the printing control apparatus 104 to acquire unit information indicating the unit of the actual quantity of “80.” In step S1412, the quantity management section 490 receives this acquisition request and causes the unit acquisition section 494 to refer to the unit information storage section 440 to acquire the unit information indicating the unit of the actual quantity in the cutting (half cutting) process. In this example, the unit acquisition section 494 acquires the “number of sheets” as the unit information of the actual quantity in the cutting (half cutting) process.

In step S1413, the unit acquisition section 494 transmits the acquired unit information to the MIS 120. In other words, the unit acquisition section 494 transmits the unit information “the number of sheets” to the MIS 120.

In step S1414, the MIS 120 transmits a request to the quantity management section 490 of the printing control apparatus 104 to acquire the planned actual quantity in the cutting (half cutting) process.

In step S1415, the quantity management section 490 receives this acquisition request and refers to the job actual result information storage section 425 to acquire the planned actual quantity in the cutting (half cutting) process. In step S1416, the quantity management section 490 transmits the planned actual quantity to the MIS 120. In this example, since the planned actual quantity in the cutting (half cutting) process is “80,” the quantity management section 490 transmits the planned actual quantity of “80” to the MIS 120.

In the present embodiment, the printing control apparatus 104 transmits the planned actual quantity and the actual quantity in the cutting (half cutting) process to the client PC 101 in this way. Specifically, in the present embodiment, the printing control apparatus 104 provides information indicating “cutting (half cutting) process, the number of sheets planned to be cut, and the number of sheets actually cut” to the client PC 101.

This configuration allows the MIS 120 of the client PC 101 to compare the planned actual quantity and the actual quantity in the cutting (half cutting) process.

In the present embodiment, the planned actual quantity and the actual quantity when the cutting (half cutting) process is completed are both “80” sheets. Therefore, the MIS 120 recognizes that the actual cutting (half cutting) has been executed in accordance with the planned number of sheets indicated by the print job.

Next, the process management section 470 executes the binding process. In step S1417, the process management section 470 of the printing control apparatus 104 requests the quantity management section 490 to acquire the quantity to be included in a binding instruction to the binding apparatus 106. Specifically, the process management section 470 requests the quantity management section 490 to acquire the planned input quantity to be input to the binding apparatus 106. This request includes the job identification ID.

In step S1418, the quantity management section 490 receives this request and causes the quantity calculation section 492 to calculate the planned input quantity and the planned actual quantity in the binding process and store the planned input quantity and the planned actual quantity in association with the job identification ID in the job actual result information storage section 425.

Specifically, the quantity calculation section 492 calculates the planned input quantity based on the calculation formula identified from the product “perfect bound interior pages” and the process “binding (perfect binding)” in the input quantity calculation formula storage section 430. In this example, since the planned input quantity is equal to the number of copies to be delivered, the quantity calculation section 492 acquires, as the planned input quantity, “10” which is the number of copies to be delivered.

The quantity calculation section 492 calculates the planned actual quantity using the calculation formula identified from the item “binding (perfect binding)” in the actual quantity calculation formula storage section 435. In this example, since the planned actual quantity is equal to the planned input quantity, the quantity calculation section 492 acquires, as the planned actual quantity, “10” which is the planned input quantity.

In step S1419, the quantity management section 490 provides the planned input quantity to the process management section 470.

In step S1420, the process management section 470 requests the binding apparatus 106 to execute the binding process. This request includes the planned input quantity of “10.”

The binding apparatus 106 executes the binding process in step S1421 and provides the execution result to the process management section 470 in step S1422. In this example, the execution result includes the number of booklets bound by the binding apparatus 106.

The execution result may also include the input quantity actually input to the binding apparatus 106. The execution result may also include identification information for identifying the binding apparatus 106. In other words, the execution result of the binding process may include the apparatus ID for identifying the apparatus that has executed the binding processing.

In the example of FIG. 14A, since a change in the processing content of the binding process is not received, the input quantity and the actual quantity in the binding process are “10” which is the same quantity as the planned input quantity and the planned actual quantity. In step S1423, the process management section 470 receives the execution result and requests the quantity management section 490 to register the actual quantity in the binding process. This request includes the job identification ID “job001” and the input quantity of “10” and the actual quantity of “10” acquired in step S1422.

In step S1424, the quantity management section 490 receives this request and causes the actual result storing section 493 to store the input quantity and the actual quantity in association with the job identification ID in the job actual result information storage section 425. In step S1425, when the actual result storing section 493 has completed storing the input quantity and the actual quantity, the quantity management section 490 notifies the process management section 470 of the completion of the storage.

In step S1426, the process management section 470 notifies the MIS 120 of the client PC 101 of the actual quantity of “10” in the binding process.

In step S1427, the MIS 120 transmits a request to the quantity management section 490 of the printing control apparatus 104 to acquire unit information indicating the unit of the actual quantity of “10.” In step S1428, the quantity management section 490 receives this request and causes the unit acquisition section 494 to refer to the unit information storage section 440 to acquire the unit information indicating the unit of the actual quantity in the binding process. In this example, the unit acquisition section 494 acquires the “number of copies” as the unit information of the actual quantity in the binding process.

In step S1429, the unit acquisition section 494 transmits the acquired unit information to the MIS 120. In other words, the unit acquisition section 494 transmits the unit information “the number of copies” to the MIS 120.

In step S1430, the MIS 120 transmits a request to the quantity management section 490 of the printing control apparatus 104 to acquire the planned actual quantity in the binding process.

In step S1431, the quantity management section 490 receives this acquisition request and refers to the job actual result information storage section 425 to acquire the planned actual quantity in the binding process in step S1431. In step S1432, the quantity management section 490 transmits the planned actual quantity to the MIS 120. In this example, since the planned actual quantity in the binding process is “10,” the quantity management section 490 transmits the planned actual quantity of “10” to the MIS 120.

In the present embodiment, the printing control apparatus 104 transmits the planned actual quantity and the actual quantity in the binding process to the client PC 101 in this way. Specifically, in the present embodiment, the printing control apparatus 104 provides information indicating “binding process, the number of copies planned to be bound, and the number of copies actually bound” to the client PC 101.

This configuration allows the MIS 120 of the client PC 101 to compare the planned actual quantity and the actual quantity in the binding process.

In the present embodiment, the planned actual quantity and the actual quantity when the binding process is completed are both “10” copies. Therefore, the MIS 120 recognizes that the actual binding has been executed in accordance with the planned number of copies indicated by the print job.

Next, the cutting (three-side cutting) process which is executed after the binding process and processing executed by the MIS 120 are described with reference to FIG. 14B. FIG. 14B is a fourth sequence diagram for describing the operation of the printing system 100

In the printing system 100, in step S1433, the process management section 470 of the printing control apparatus 104 requests the quantity management section 490 to acquire the quantity to be included in a cutting instruction to a cutting apparatus 105B. Specifically, the process management section 470 requests the quantity management section 490 to acquire the planned input quantity to be input to the cutting apparatus 105B. This request includes the job identification ID. The cutting apparatus 105B is an example of a processing apparatus that executes three-side cutting.

In step S1434, the quantity management section 490 receives this request and causes the quantity calculation section 492 to calculate the planned input quantity and the planned actual quantity in the cutting (three-side cutting) process and store the calculated planned input quantity and planned actual quantity in association with the job identification ID in the job actual result information storage section 425.

Specifically, the quantity calculation section 492 calculates the planned input quantity based on the calculation formula identified from the product “perfect bound interior pages” and the process “cutting (three-side cutting)” in the input quantity calculation formula storage section 430. In this example, since the planned input quantity is equal to the number of copies to be delivered, the quantity calculation section 492 acquires, as the planned input quantity, “10” which is the number of copies to be delivered.

The quantity calculation section 492 calculates the planned actual quantity using the calculation formula identified from the item “cutting (three-side cutting)” in the actual quantity calculation formula storage section 435. In this example, since the planned actual quantity is equal to the planned input quantity, the quantity calculation section 492 acquires, as the planned actual quantity, “10” which is the planned input quantity.

In step S1435, the quantity management section 490 provides the planned input quantity to the process management section 470.

In step S1436, the process management section 470 requests the cutting apparatus 105B to execute the cutting (three-side cutting) process. This request includes the planned input quantity of “10.”

The cutting apparatus 105B executes the cutting process in step S1437 and provides the execution result to the process management section 470 in step S1438. In this example, the execution result includes the number of booklets cut by the cutting apparatus 105B. The execution result may also include the input quantity actually input to the cutting apparatus 105B. The execution result may also include identification information for identifying the cutting apparatus 105B. In other words, the execution result of the cutting (three-side cutting) process may include the apparatus ID for identifying the apparatus that has executed the cutting (three-side cutting) processing.

In the example of FIG. 14B, since a change in the processing content of the cutting (three-side cutting) process is not received, the input quantity and the actual quantity in the cutting (three-side cutting) process are “10” which is the same quantity as the planned input quantity and the planned actual quantity.

In step S1439, the process management section 470 receives the execution result and requests the quantity management section 490 to register the actual quantity in the cutting (three-side cutting) process. This request includes the job identification ID “job001” and the input quantity of “10” and the actual quantity of “10” acquired in step S1438.

In step S1440, the quantity management section 490 receives this request and causes the actual result storing section 493 to store the input quantity and the actual quantity in association with the job identification ID in the job actual result information storage section 425. In step S1441, when the actual result storing section 493 has completed storing the input quantity and the actual quantity, the quantity management section 490 notifies the process management section 470 of the completion of the storage.

In step S1442, the process management section 470 notifies the MIS 120 of the client PC 101 of the actual quantity of “10” in the cutting (three-side cutting) process.

In step S1443, the MIS 120 transmits a request to the quantity management section 490 of the printing control apparatus 104 to acquire the unit information indicating the unit of the actual quantity of “10.” In step S1444, the quantity management section 490 receives this acquisition request and causes the unit acquisition section 494 to refer to the unit information storage section 440 to acquire the unit information indicating the unit of the actual quantity in the cutting (three-side cutting) process. In this example, the unit acquisition section 494 acquires “the number of copies” as the unit information of the actual quantity in the cutting (three-side cutting) process.

In step S1445, the unit acquisition section 494 transmits the acquired unit information to the MIS 120. In other words, the unit acquisition section 494 transmits the unit information “the number of copies” to the MIS 120.

In step S1446, the MIS 120 transmits a request to the quantity management section 490 of the printing control apparatus 104 to acquire the planned actual quantity in the cutting (three-side cutting) process.

In step S1447, the quantity management section 490 receives this acquisition request and refers to the job actual result information storage section 425 to acquire the planned actual quantity in the cutting (three-side cutting) process. In step S1448, the quantity management section 490 transmits the planned actual quantity to the MIS 120. In this example, since the planned actual quantity in the cutting (three-side cutting) process is “10,” the quantity management section 490 transmits the planned actual quantity of “10” to the MIS 120.

In the present embodiment, the printing control apparatus 104 transmits the planned actual quantity and the actual quantity in the cutting (three-side cutting) process to the client PC 101. In other words, in the present embodiment, the printing control apparatus 104 provides information indicating “cutting (three-side cutting) process/the number of copies planned to be cut/the number of copies actually cut” to the client PC 101.

This configuration allows the MIS 120 of the client PC 101 to compare the planned actual quantity and the actual quantity when the cutting (three-side cutting) process is completed.

In the present embodiment, the planned actual quantity and the actual quantity when the cutting (three-side cutting) process is completed are both “10” copies. Therefore, the MIS 120 recognizes that the cutting (three-side cutting) process has been executed in accordance with the planned number of copies indicated by the print job.

In step S1449, the MIS 120 of the client PC 101 transmits a request to the quantity management section 490 of the printing control apparatus 104 to acquire process pattern information associated with the print job. In step S1450, the quantity management section 490 receives this acquisition request and acquires the process pattern information associated with the process pattern ID identified by the process identification section 491. In step S1451, the quantity management section 490 transmits the acquired process pattern information to the client PC 101.

In step S1452, when the MIS 120 of the client PC 101 acquires the process pattern information, the MIS 120 performs the single-item profit and loss calculation.

In the present embodiment, as described above, the printing control apparatus 104 compares the planned actual quantity and the actual quantity for each process included in a process pattern identified from a print job. In the present embodiment, the printing control apparatus 104 may cause the client PC 101 to display, on the display of the client PC 101, information indicating a magnitude relationship between the planned actual quantity and the actual quantity for each process. In the present embodiment, each process may be provided with a flag as information indicating the magnitude relationship between the planned actual quantity and the actual quantity.

The configuration according to the present embodiment allows the user of the client PC 101 and the printing control apparatus 104 to, for example, check the actual quantity against the planned actual quantity for each process.

In the printing control apparatus 104 according to the present embodiment, the display control section 465 may display, on the display 506, a screen including a printing condition of a print job before each process is executed and receive, if any, a change in the printing condition on the screen. The display control section 465 may also display the execution result of a preceding process on this screen.

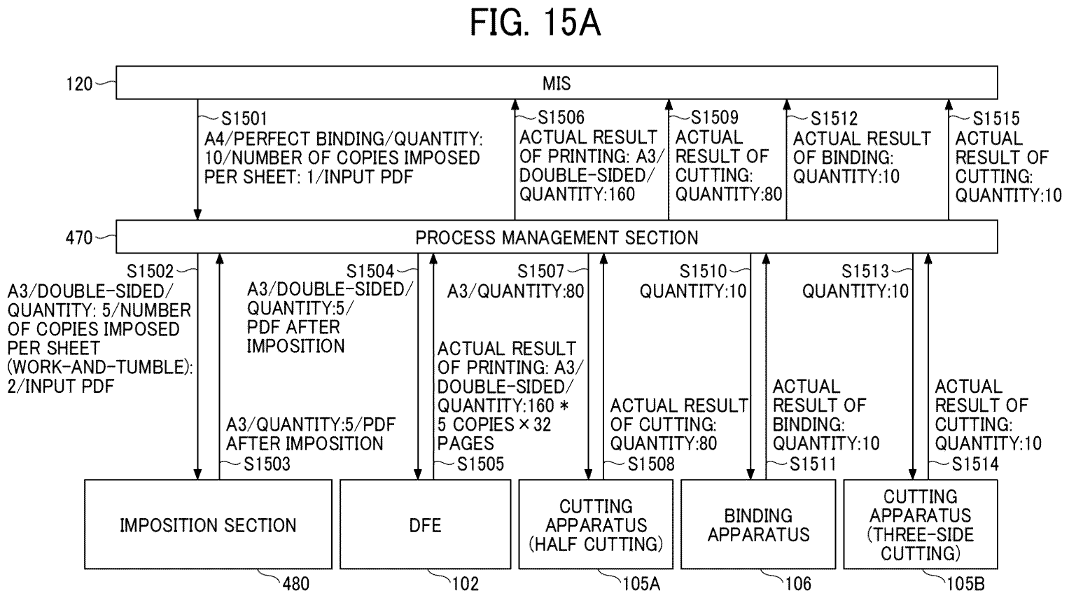

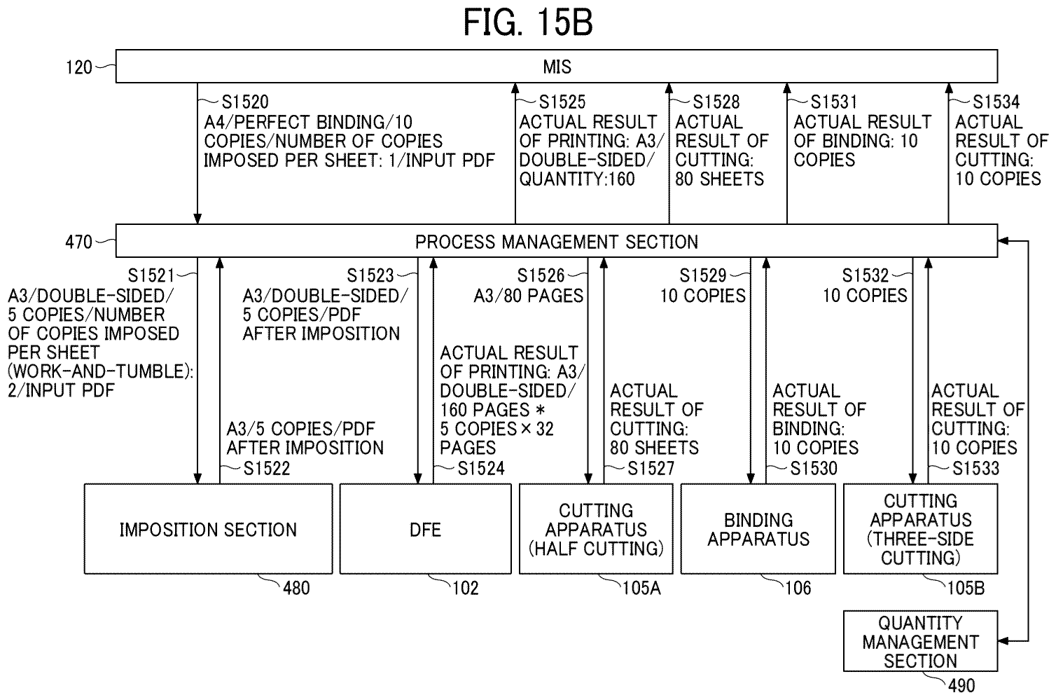

An advantageous effect of the present embodiment is described below with reference to FIGS. 15A and 15B. FIG. 15A is a first diagram for describing the advantageous effect of the present embodiment. FIG. 15A illustrates an example where a printing system does not include the quantity management section 490 and is instructed to execute the job identified from the job identification ID “job001” as in the case of FIGS. 13 and 14. Further, in the example of FIG. 15A, the number of copies imposed per sheet included in the printing condition is changed from “1” to “2” before the imposition process starts, as in the example of FIGS. 13 and 14.

In this case, in step S1501, the process management section 470 receives, from the MIS 120, a work instruction indicating that the quantity included in the printing condition is “10.” In step S1502, the process management section 470 changes the number of copies imposed per sheet from “1” to “2” in the printing condition and instructs the imposition section 480 to execute the imposition process.

In step S1503, the imposition section 480 imposes two copies on each sheet and returns, to the process management section 470, the quantity of “5” which is the number of copies of the input content data after imposition.

In step S1504, the process management section 470 instructs the DFE 102 to execute printing with the quantity of “5” as the planned input quantity. In step S1505, the DFE 102 acquires, from the image forming apparatus 103, the quantity of “160” which is the number of pages printed in step S1504 and returns the quantity of “160” to the process management section 470. In step S1506, the process management section 470 transmits, to the MIS 120, the quantity of “160” as the execution result of the printing process, together with the identification information for identifying the DFE 102 or the image forming apparatus 103.

In step S1507, the process management section 470 instructs the cutting apparatus 105A to execute cutting (half cutting) with the quantity of “80” as the planned input quantity. In step S1508, the cutting apparatus 105A returns, to the process management section 470, the quantity of “80” which is the number of cut sheets. In step S1509, the process management section 470 transmits, to the MIS 120, the quantity of “80” as the execution result of the cutting (half cutting) process, together with the identification information for identifying the cutting apparatus 105A.

In step S1510, the process management section 470 instructs the binding apparatus 106 to execute binding with the number of copies to be delivered set to “10” as the planned input quantity. In step S1511, the binding apparatus 106 returns the number of bound copies of “10” to the process management section 470. In step S1512, the process management section 470 transmits, to the MIS 120, the quantity of “10” as the execution result of the binding process, together with the identification information for identifying the binding apparatus 106.

In step S1513, the process management section 470 instructs the cutting apparatus 105B to execute cutting (three-side cutting) with the number of copies to be delivered set to “10” as the planned input quantity. In step S1514, the cutting apparatus 105B returns, to the process management section 470, the quantity of “10” which is the number of cut copies. In step S1515, the process management section 470 transmits, to the MIS 120, the quantity of “10” as the execution result of the cutting process (three-side cutting), together with the identification information for identifying the cutting apparatus 105B.

In the example of FIG. 15A, the MIS 120 is notified of the actual quantity associated with each process from the process management section 470 but is not notified of the unit of the actual quantity. Therefore, in the example of FIG. 15A, the MIS 120 is unable to determine the unit of the notified quantity.

Therefore, in the example of FIG. 15A, the MIS 120 performs single-item profit and loss calculation after the user manually associates each quantity with the corresponding unit or performs single-item profit and loss calculation without knowing a relationship between the notified quantities. Therefore, in the example of FIG. 15A, the MIS 120 is unable to automatically perform single-item profit and loss calculation with high accuracy. In other words, it is difficult for the printing system illustrated in FIG. 15A to properly manage the progress of each print job and the processing result since the unit of the quantity for each process is unknown.

In the example of FIG. 15B, the printing system 100 includes the quantity management section 490 according to the present embodiment.

FIG. 15B is a second diagram for describing the advantageous effect of the present embodiment. In the example of FIG. 15B, the printing system 100 is instructed to execute the job identified from the job identification ID “job001” and the number of copies imposed per sheet included in the printing condition is changed from “1” to “2” before the imposition process starts, as in the example of FIGS. 13 and 14.

In this case, in step S1520, the process management section 470 receives, from the MIS 120, a work instruction indicating that the quantity included in the printing condition is “10.” In step S1521, the process management section 470 also changes the number of copies imposed per sheet from “1” to “2” in the printing condition and instructs the imposition section 480 to execute the imposition process.

In step S1522, the imposition section 480 imposes two copies on each sheet and returns, to the process management section 470, the quantity of “5” which is the number of copies of the input content data after imposition and the unit “copy” which is the unit of the quantity of “5.”

In step S1523, the process management section 470 instructs the DFE 102 to execute printing with the quantity of “5” as the planned input quantity. In step S1524, the DFE 102 acquires, from the image forming apparatus 103, the quantity of “160” which is the number of pages printed and returns the quantity of “160” to the process management section 470. In step S1525, the process management section 470 transmits, to the MIS 120, “160 pages” based on the quantity of “160” and the unit “the number of pages” as the execution result of the printing process. At this time, the process management section 470 also transmits the identification information for identifying the DFE 102 or the image forming apparatus 103 to the MIS 120.

In step S1526, the process management section 470 instructs the cutting apparatus 105A to execute cutting (half cutting) with the quantity of “80” as the planned input quantity. In step S1527, the cutting apparatus 105A returns, to the process management section 470, the quantity of “80” which is the number of cut sheets. In step S1528, the process management section 470 transmits, to the MIS 120, “80 sheets” as the execution result of the cutting (half cutting) process, together with the identification information for identifying the cutting apparatus 105A.

In step S1529, the process management section 470 instructs the binding apparatus 106 to execute binding with the number of copies to be delivered set to “10” as the planned input quantity. In step S1530, the binding apparatus 106 returns, to the process management section 470, the quantity of “10” which is the number of bound copies. In step S1531, the process management section 470 transmits, to the MIS 120, “10 copies” as the execution result of the binding process, together with the identification information for identifying the binding apparatus 106.

In step S1532, the process management section 470 instructs the cutting apparatus 105B to execute cutting (three-side cutting) with the number of copies to be delivered set to “10” as the planned input quantity. In step S1533, the cutting apparatus 105B returns, to the process management section 470, the quantity of “10” which is the number of cut copies. In step S1534, the process management section 470 transmits, to the MIS 120, “10 copies” as the execution result of the cutting process (three-side cutting), together with the identification information for identifying the cutting apparatus 105B.

In this way, in the present embodiment, the process management section 470 provides the MIS 120 with the actual quantity associated with the process and the unit of the actual quantity.

In the present embodiment, the MIS 120 is also provided with the planned actual quantity in each process. Therefore, the configuration according to the present embodiment allows the MIS 120 to determine to what extent processing has been executed in each process against the planned actual quantity included in the work instruction.

Moreover, the configuration according to the present embodiment allows the MIS 120 to perform single-item profit and loss calculation using the actual quantity acquired in each process. This configuration, therefore, enhances the calculation accuracy.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The illustrated apparatuses are only illustrative of one of several computing environments for implementing the embodiment disclosed herein.

For example, in some embodiments, the printing control apparatus 104 includes a plurality of computing devices, e.g., a server cluster, that are configured to communicate with each other over any type of communications link, including a network, a shared memory, etc. to collectively perform the processing disclosed herein. Similarly, the printing control apparatus 104 can include a plurality of computing devices that are configured to communicate with each other.

Further, the printing control apparatus 104 may be configured to share the processing steps disclosed herein in various combinations. For example, processing executed by a predetermined unit may be executed by the printing control apparatus 104. Similarly, the function of a predetermined unit may be executed by the printing control apparatus 104. Further, the components of the printing control apparatus 104 may be collectively disposed in a single server or divided into a plurality of apparatuses.

The printing control apparatus 104 may be any apparatus with a communication function. The printing control apparatus 104 may be, for example, a projector (PJ), an output apparatus such as digital signage, a head-up display (HUD), an industrial machine, an imaging apparatus, a sound collection apparatus, a medical apparatus, a network home appliance, an automobile (connected car), a laptop computer, a mobile phone, a smartphone, a tablet terminal, a game console, a personal digital assistant (PDA), a digital camera, a wearable PC, or a desktop PC.

Aspects of the present disclosure are, for example, as follows.

According to Aspect 1, a printing system includes an image forming apparatus and a printing control apparatus. The printing control apparatus includes a job reception section and a quantity management section. The job reception section receives an input of a print job for the image forming apparatus. The quantity management section refers to, for each of a plurality of processes identified based on the print job, a unit information storage section storing a plurality of pieces of unit information each indicating a unit of a quantity for a corresponding one of the plurality of processes, and manages the quantity for each of the plurality of processes identified based on the print job received by the job reception section in association with the unit of the quantity for the corresponding one of the plurality of processes.

According to Aspect 2, in the printing system of Aspect 1, the quantity management section associates, for each of the plurality of processes, an actual quantity indicating an execution result of a corresponding one of the plurality of processes when the print job received by the job reception section is executed with information indicating a unit corresponding to the actual quantity and outputs the associated actual quantity and information indicating the unit to an input source of the print job.

According to Aspect 3, in the printing system of Aspect 2, the quantity management section includes a process identification section and a quantity calculation section. The process identification section refers to a process pattern storage section storing a plurality of pieces of process pattern information each including a plurality of processes in association with a printing condition indicated by the print job received by the job reception section. The process identification section identifies, based on the printing condition indicated by the print job received by the job reception section, process pattern information including a plurality of processes associated with the printing condition indicated by the print job received by the job reception section among the plurality of pieces of process pattern information. The quantity calculation section calculates, for each of the plurality of processes indicated by the process pattern information identified by the process identification section, a quantity for a corresponding one of the plurality of processes indicated by the process pattern information based on a quantity included in the printing condition indicated by the print job received by the job reception section.

According to Aspect 4, in the printing system of Aspect 3, the quantity for each of the plurality of processes indicated by the process pattern information identified by the process identification section includes a planned input quantity and a planned actual quantity.

The planned input quantity is determined based on the quantity included in the printing condition indicated by the print job received by the job reception section. The planned actual quantity indicates an execution result of a corresponding one of the plurality of processes indicated by the process pattern information identified by the process identification section when the print job received by the job reception section is executed.

According to Aspect 5, in the printing system of Aspect 4, the quantity management section further includes an actual result storing section. The actual result storing section acquires the actual quantity for each of the plurality of processes indicated by the process pattern information identified by the process identification section and stores the acquired actual quantity in a job actual result information storage section. The quantity calculation section refers to a calculation formula storage section storing a calculation formula for calculating the planned actual quantity for each of the plurality of processes, and calculates the planned actual quantity for each of the plurality of processes indicated by the process pattern information identified by the process identification section. The actual result storing section stores, in the job actual result information storage section, the planned actual quantity calculated by the quantity calculation section in association with the actual quantity for each of the plurality of processes indicated by the process pattern information identified by the process identification section.

According to Aspect 6, in the printing system of Aspect 5, the quantity calculation section refers to the calculation formula storage section storing a calculation formula for calculating the planned input quantity for each of a plurality of processes, and calculates the planned input quantity for each of the plurality of processes indicated by the process pattern information identified by the process identification section. The actual result storing section acquires, when the print job received by the job reception section is executed, an input quantity input for each of the plurality of processes indicated by the process pattern information identified by the process identification section, and stores, in the job actual result information storage section, the planned input quantity calculated by the quantity calculation section in association with the input quantity for each of the plurality of processes indicated by the process pattern information identified by the process identification section.

According to Aspect 7, a printing control apparatus includes a job reception section and a quantity management section. The job reception section receives an input of a print job for an image forming apparatus. The quantity management section refers to, for each of a plurality of processes identified based on the print job, a unit information storage section storing a plurality of pieces of unit information each indicating a unit of a quantity for a corresponding one of the plurality of processes, and manages the quantity for each of the plurality of processes identified based on the print job received by the job reception section in association with the unit of the quantity for the corresponding one of the plurality of processes.

According to Aspect 8, a printing control method is performed by a printing system including an image forming apparatus and a printing control apparatus. The printing control method includes, by the printing control apparatus, receiving an input of a print job for the image forming apparatus, referring to, for each of a plurality of processes identified based on the print job, a unit information storage section storing a plurality of pieces of unit information each indicating a unit of a quantity for a corresponding one of the plurality of processes, and managing the quantity for each of the plurality of processes identified based on the received print job in association with the unit of the quantity for the corresponding one of the plurality of processes.

According to Aspect 9, a printing control program causes a printing control apparatus to perform processing including receiving an input of a print job for an image forming apparatus, referring to, for each of a plurality of processes identified based on the print job, a unit information storage section storing a plurality of pieces of unit information each indicating a unit of a quantity for a corresponding one of the plurality of processes, and managing the quantity for each of the plurality of processes identified based on the received print job in association with the unit of the quantity for the corresponding one of the plurality of processes.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A printing control apparatus comprising circuitry configured to:
receive an input of a print job for an image forming apparatus;
refer to, for each of a plurality of processes identified based on the print job, unit information stored in a memory and indicating a unit of a quantity for a corresponding one of the plurality of processes; and
associate the quantity for each of the plurality of processes identified based on the print job with the unit of the quantity for the corresponding one of the plurality of processes.

2. The printing control apparatus according to claim 1, wherein the circuitry is configured to, for each of the plurality of processes,
associate an actual quantity indicating an execution result of the corresponding one of the plurality of processes when the print job is executed with information indicating a unit corresponding to the actual quantity, and
output the actual quantity and the information indicating the unit that are associated to an input source of the print job.

3. The printing control apparatus according to claim 2, wherein the circuitry is configured to:
refer to a plurality of pieces of process pattern information each including a plurality of processes and stored in the memory in association with a plurality of printing conditions indicated by a plurality of print jobs;
identify, based on the printing condition indicated by the print job that is input, particular process pattern information including the plurality of processes associated with the printing condition indicated by the print job among the plurality of pieces of process pattern information; and
calculate, for each of the plurality of processes indicated by the particular process pattern information, a quantity for a corresponding one of the plurality of processes based on a quantity included in the printing condition indicated by the print job.

4. The printing control apparatus according to claim 3, wherein the quantity for each of the plurality of processes indicated by the particular process pattern information includes:
a planned input quantity determined based on the quantity included in the printing condition indicated by the print job; and
a planned actual quantity indicating an execution result of the corresponding one of the plurality of processes when the print job is executed.

5. The printing control apparatus according to claim 4, wherein the circuitry is configured to:
acquire the actual quantity for each of the plurality of processes indicated by the particular process pattern information and store the acquired actual quantity in the memory;
calculate the planned actual quantity for each of the plurality of processes indicated by the particular process pattern information using a calculation formula for calculating the planned actual quantity, the calculation formula for calculating the planned actual quantity being stored in the memory for each of the plurality of processes; and
store, in the memory, the calculated planned actual quantity in association with the actual quantity for each of the plurality of processes indicated by the particular process pattern information.

6. The printing control apparatus according to claim 5, wherein the circuitry is configured to:
calculate the planned input quantity for each of the plurality of processes indicated by the particular process pattern information using a calculation formula for calculating the planned input quantity, the calculation formula for calculating the planned input quantity being stored in the memory for each of the plurality of processes;
acquire, when the print job is executed, an input quantity input for each of the plurality of processes indicated by the particular process pattern information; and
store, in the memory, the calculated planned input quantity in association with the input quantity for each of the plurality of processes indicated by the particular process pattern information.

7. A printing system comprising:
the printing control apparatus according to claim 1; and
the image forming apparatus to print an image based on the print job.

8. A printing control method comprising:
receiving an input of a print job for an image forming apparatus;
referring to, for each of a plurality of processes identified based on the print job, unit information stored in a memory and indicating a unit of a quantity for a corresponding one of the plurality of processes; and
associating the quantity for each of the plurality of processes identified based on the print job with the unit of the quantity for the corresponding one of the plurality of processes.

9. A non-transitory recording medium storing a plurality of instructions which, when executed by one or more processors, causes the one or more processors to perform a method comprising:
receiving an input of a print job for an image forming apparatus;
referring to, for each of a plurality of processes identified based on the print job, unit information stored in a memory and indicating a unit of a quantity for a corresponding one of the plurality of processes; and
associating the quantity for each of the plurality of processes identified based on the print job with the unit of the quantity for the corresponding one of the plurality of processes.
